(19) United States
(12) Patent Application Publication
(10) Pub. No.: US 2025/0184878 A1
(43) Pub. Date: Jun. 5, 2025

(54) NETWORK GUIDED INITIAL NETWORK/CELL-SEARCH

(71) Applicant: FRAUNHOFER-GESELLSCHAFT ZUR FOERDERUNG DER ANGEWANDTEN FORSCHUNG E.V., Muenchen (DE)

(72) Inventors: Gustavo Wagner Oliveira da Costa, Erlangen (DE); Dietmar Lipka, Erlangen (DE); Martin Leyh, Erlangen (DE); Geordie George, Erlangen (DE); Elke Roth-Mandutz, Erlangen (DE); Julian Popp, Erlangen (DE)

(21) Appl. No.: 19/045,590

(22) Filed: Feb. 5, 2025

Related U.S. Application Data
(63) Continuation of application No. PCT/EP2023/071661, filed on Aug. 4, 2023.

(30) Foreign Application Priority Data
Aug. 5, 2022 (EP) 22189033.8

(51) Int. Cl. H04W 48/16; H04W 56/00

(52) U.S. Cl. CPC H04W 48/16; H04W 56/001

(57) ABSTRACT

Embodiments provide a transceiver [e.g., UE], wherein the transceiver is configured, in a network search mode [e.g., cell search mode], to search for a presence indicator signal, the presence indicator signal indicating a presence of a wireless [e.g., radio based] communication network [e.g., 5G/NR communication network], wherein the presence indicator signal is associated in frequency with a group [e.g., block] of channels used by the wireless communication network [e.g., for synchronization], the group of channels comprising at least two channels, wherein the transceiver is configured, upon detecting the presence indicator signal, to search for a synchronization signal [e.g., synchronization signal block, SSB] in one or more channels of the group of channels.

### CROSS-REFERENCE TO RELATED APPLICATIONS

This application is a continuation of copending International Application No. PCT/EP2023/071661, filed Aug. 4, 2023, which is incorporated herein by reference in its entirety, and additionally claims priority from European Application No. 22189033.8, filed Aug. 5, 2022, which is also incorporated herein by reference in its entirety.

### TECHNICAL FIELD

Embodiments of the present application relate to the field of wireless communication, and more specifically, to wireless communication between a user equipment and a base station. Some embodiments relate to network guided initial network/cell-search.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . RANN. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, initial network search, or more specifically, initial cell search is the process performed by user equipments (UEs) when they have no a priori information about the RF environment. This may be the case, for example, when a UE is switched on for the first time or when a UE is switched on in a different country.

According to [1], during ICS a UE may search all RF channels until finding a suitable cell, if it cannot detect a cell on its list of preferred and recently visited Public Land Mobile Networks (PLMNs). The frequency positions which may contain SSBs are defined [2] and [3] in the synchronization raster. Given the large amount of positions a UE needs to check, the initial cell search process may last long and consume a lot of UE battery.

In general, a UE may plan the evaluation time of a frequency position by assuming any acceptable or suitable cell will be transmitting SSBs every 20 ms or more often (see [4]). During this time the UE tries to detect one or more primary synchronization signals (PSS). If a PSS is found, the UE will proceed with further synchronization with the secondary synchronization signals (SSS) and then read the main system information from the PBCH, which carries the Master Information Block (MIB), to evaluate if a cell is suitable or not.

In [5], the possible SSB periodicities are defines as:
ssb-periodicityServingCell ENUMERATED {ms5, ms10, ms20, ms40, ms80, ms160, spare2, spare1}

In multi-beam operation this periodicity apply between SSB burst sets. For this reason “SSB periodicity” and “SSB burst set periodicity” should be understood as synonyms: they define the periodicity at SSB burst sets start no matter if a single SSB is transmitted or multiple SSBs are transmitted for the sake of beam management. In multi-beam operation in 5G NR the SSBs are confined to the first 5 ms of the SSB period.

In the literature several approaches to optimize the order of evaluation of the RF channels for ICS can be found. For example, a UE may first evaluate frequency positions on bands which contain deployment more often, or typically have better coverage. But ultimately, in any of such approaches the worst case is still that only the last evaluated RF channel contains an SSB. Thus, optimizations of evaluation order may help reducing the average time for ICS but still suffer from a bad worst case.

However, there is a trade-off to choose between either a reliable ICS or a more pervasive NES, the current solution in most cases is that operators need to keep a layer of cells with 20 ms SSB period even if there is no traffic at all (e.g. at night). This layer will typically be macrocells planned to provide basic coverage and mobility. In small cells or secondary component carriers it could be acceptable to have larger SSB periodicities even if ICS suffers, relying that ICS will succeed on the network layer where cells have a 20 ms period. Still, the energy savings would be limited by the amount of cells which cannot have a period larger than 20 ms even at zero load.

Therefore, there is the need of reducing the time required for ICS.

It is noted that the information in the above section is only for enhancing the understanding of the background of the invention and therefore it may contain information that does not form conventional technology and is already known to a person of ordinary skill in the art.

SUMMARY

An embodiment may have a transceiver, wherein the transceiver is configured, in a search mode, to search for a presence indicator signal, the presence indicator signal indicating a presence of
a wireless communication network, or
a cell of the wireless communication network, or
a beam of a cell of the wireless communication network,
   wherein the presence indicator signal is associated in frequency with a group of channels used by the wireless communication network, the group of channels having at least two channels, wherein the transceiver is configured, upon detecting the presence indicator signal, to search for a synchronization signal in one or more channels of the group of channels.

Another embodiment may have a base station of a wireless communication network, wherein the base station is configured to transmit a presence indicator signal, the presence indicator signal indicating a presence of
the wireless communication network, or
or a cell of the wireless communication network, or
or a beam of a cell of the wireless communication network,
   wherein the presence indicator signal is associated in frequency with a group of frequencies used by the wireless communication network for transmitting one or more synchronization signals, the group of channels having at least two channels.

According to another embodiment, a wireless communication network may have: a transceiver according to the invention as mentioned above, and a base station according to the invention as mentioned above.

Another embodiment may have a transceiver, wherein the transceiver is configured, in a search mode, to search for a presence indicator signal, the presence indicator signal indicating a presence of a wireless communication network, wherein the presence indicator signal is associated in frequency with a group of channels used by the wireless communication network, the group of channels having at least two channels, wherein the transceiver is configured, upon detecting the presence indicator signal, to search for a broadcast signal in one or more channels of the group of channels.

Still another embodiment may have a base station of a wireless communication network, wherein the base station is configured to transmit a presence indicator signal, the presence indicator signal indicating a presence of the wireless communication network, wherein the presence indicator signal is associated in frequency with a group of frequencies used by the wireless communication network for transmitting one or more synchronization signals, the group of channels having at least two channels.

Another embodiment may have a transceiver, wherein the transceiver is configured, in a search mode, to search for a presence indicator signal, the presence indicator signal indicating a presence of another transceiver, wherein the presence indicator signal is associated in frequency with a group of channels used by the second transceiver, the group of channels having at least two channels, wherein the first transceiver is configured, upon detecting the presence indicator signal associated in frequency with the group of channels used by the second transceiver, to search for a synchronization signal in one or more channels of the group of channels used by the other transceiver.

Another embodiment may have another transceiver, wherein the other transceiver is configured to transmit a presence indicator signal, the presence indicator signal indicating a presence of the other transceiver, wherein the presence indicator signal is associated in frequency with a group of channels used by the second transceiver, the group of channels having at least two channels.

According to another embodiment, a method for operating a transceiver may have the steps of: searching, in a search mode, for a presence indicator signal, the presence indicator signal indicating a presence of
a wireless communication network, or
a cell of the wireless communication network, or
a beam of a cell of the wireless communication network,
   wherein the presence indicator signal is associated in frequency with a group of channels used by the wireless communication network, the group of channels having at least two channels, and searching, upon detecting the presence indicator signal, for a synchronization signal in one or more channels of the group of channels.

According to another embodiment, a method for operating a base station of a wireless communication network may have the step of: transmitting a presence indicator signal, the presence indicator signal indicating a presence of
the wireless communication network, or
or a cell of the wireless communication network, or
or a beam of a cell of the wireless communication network,
   wherein the presence indicator signal is associated in frequency with a group of channels used by the wireless communication network for transmitting one or more synchronization signals, the group of channels having at least two channels.

According to another embodiment, a method for operating a transceiver may have the steps of: searching, in a search mode, for a presence indicator signal, the presence indicator signal indicating a presence of a wireless communication network, wherein the presence indicator signal is associated in frequency with a group of channels used by the wireless communication network, the group of channels having at least two channels, searching, upon detecting the presence indicator signal, for a broadcast signal in one or more channels of the group of channels.

According to another embodiment, a method for operating a base station of a wireless communication network may have the step of: transmitting a presence indicator signal, the presence indicator signal indicating a presence of the wireless communication network, wherein the presence indicator signal is associated in frequency with a group of channels used by the wireless communication network for transmitting one or more synchronization signals, the group of channels having at least two channels.

According to another embodiment, a method for operating a transceiver may have the steps of: searching, in a search mode, for a presence indicator signal, the presence indicator signal indicating a presence of another transceiver, wherein the presence indicator signal is associated in frequency with a group of channels used by the second transceiver, the group of channels having at least two channels, searching, upon detecting the presence indicator signal associated in frequency with the group of channels used by the second transceiver, for a synchronization signal in one or more channels of the group of channels used by the other transceiver.

According to another embodiment, a method for operating another transceiver may have the step of: transmitting a presence indicator signal, the presence indicator signal indicating a presence of the other transceiver, wherein the presence indicator signal is associated in frequency with a group of channels used by the second transceiver, the group of channels having at least two channels.

Another embodiment may have a non-transitory digital storage medium having a computer program stored thereon for performing any of the above methods according to the invention when the computer program runs on a computer, microprocessor or software defined radio.

### BRIEF DESCRIPTION OF THE DRAWINGS

Embodiments of the present invention are described herein making reference to the appended drawings, in which:

FIG. 1a is a schematic representation of an example of a wireless communication system;

FIG. 1b is a schematic representation of an example of a radio access network illustrated in FIG. 1a;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 shows a schematic representation of a grouping of channels on the synchronization raster in blocks (or groups);

FIG. 8 shows a schematic representation of several SPI deployment options;

FIG. 9 shows a schematic representation of a definition of a new frequency raster for system presence indicator signals, where frequency positions of the system presence indicator signals are different from the synchronization raster, wherein synchronization channels are grouped in blocks;

FIG. 10 is a schematic representation of a gNB coverage area, cell coverage areas as well as within one of the cells an association of SPI beams to SSB beams;

FIG. 11 shows in diagrams a power consumption over time for synchronization signal block SSB, bursts that are transmitted periodically every 20 ms or 160 ms, respectively; and

FIG. 12 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As already indicated in the introductory portion, initial cell search is the process performed by user equipments (UEs) when they have no a priori information about the RF environment. This may be the case, for example, when a UE is switched on the first time or when the UE is switched on in a different country.

Also, initial cell search (ICS) is performed by user equipments (UEs) any time when its list of detected cells is empty, which is the case after switch on or when it has lost coverage. Commercial UE platforms provide and maintain lists of e.g. preferred, forbidden, recently visited networks etc., which are considered first during ICS. This keeps the ICS cost low, since in most cases a suitable cell is found quickly. Only if no cell on the list is found, the UE starts a frequency scan (aka PLMN scan or selection (PLMN=public land mobile network)) which in case of 5G attempts carrier frequencies in steps of the synchronization raster, e.g. 1.44 MHZ. This may turn into a major waste of power. Generally, the need for initial cell search (ICS) with frequency scan should be infrequent (e.g., period in order of minutes, according to [7], ch. 5.5)

Generally, the need for initial cell search (ICS) should be infrequent but when this need arises the ICS may be a lengthy process consuming a lot of time and UE battery, especially if no cell is found and the ICS has to be repeated, periodically. Hence, there is always a concern to keep the total time for ICS bounded.

Embodiments described herein allow for accelerating the ICS. Faster ICS has merits by itself, but according to some embodiments, accelerated ICS allows for network energy saving (NES). A number of functionalities, including ICS relies on the broadcast transmission of synchronization signal block (SSB). For the sake of NES, it would be highly desirable to transmit the broadcast information (SSB burst) less often. In this way a gNB would have enough time to transition to any kind of energy-saving state, e.g. a sleep mode between two SSB transmissions and save a lot of energy in the case there is no or infrequent load at that cell.

However, in the 5G NR specifications, there is a fundamental limitation (due to an ICS requirement) which may hinder using more sparse SSB bursts. In [4], it is stated: “For initial cell selection, a UE may assume that half frames with SS/PBCH blocks occur with a periodicity of two frames.” In essence, that implies that a UE performing initial cell search can try to find a signal on a certain frequency for a certain time window (dependent of these 20 ms periods) and if not successful, it can already try the next frequency. If the SSB burst set period is increased, the time needed to evaluate a frequency increases too.

Therefore, an SSB period larger than 20 ms implies that this cell may be missed by a UE performing initial cell search as the UE is expecting an SSB every 20 ms or more often. For this reason, operators are left with the following dilemma: for a certain cell, they can either save network energy at zero/infrequent load or having a reliable initial cell search. Both are not possible,simultaneously. Embodiments described herein solve this problem, enabling fast and reliable initial cell search and at the same time allowing cells to benefit from a NES mode with sparser SSB periodicity.

Embodiments described herein allow for reducing the time required for ICS.

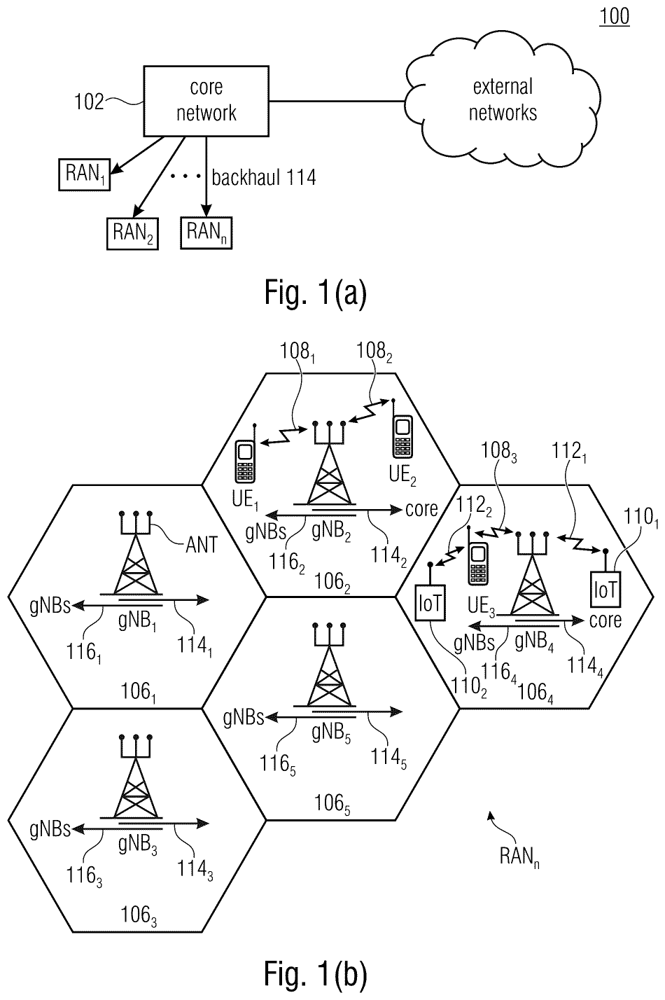

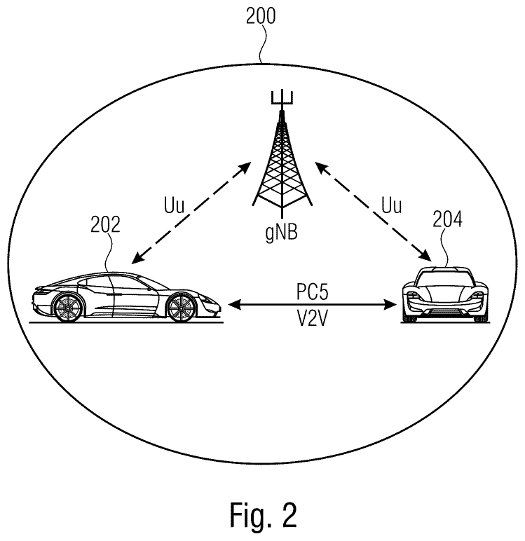

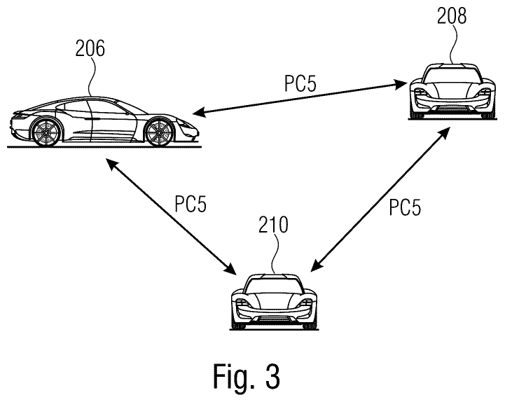

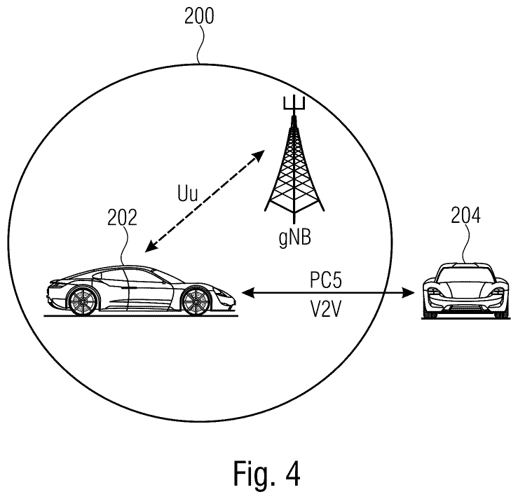

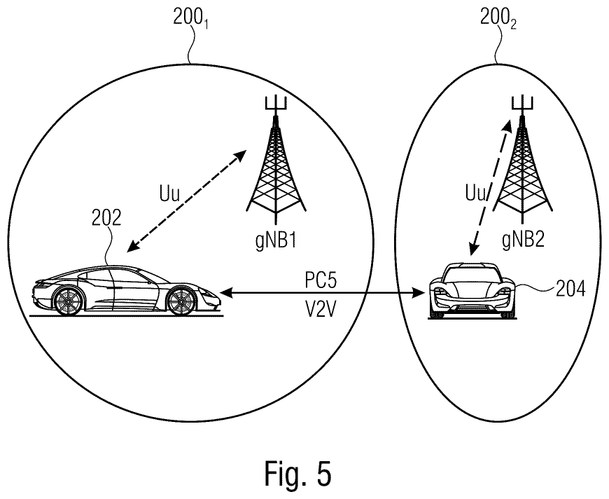

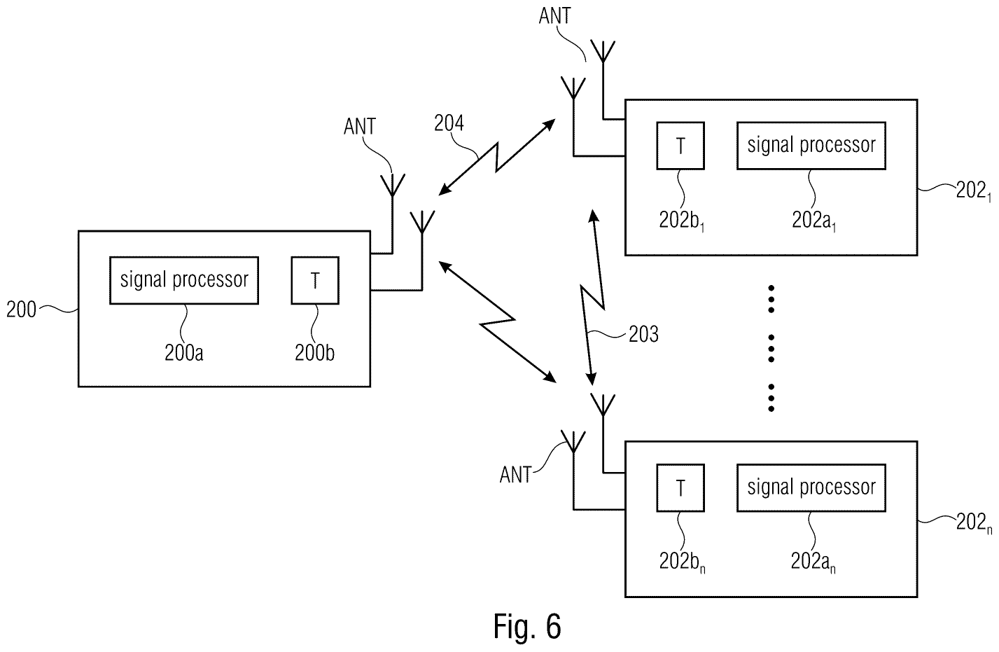

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station or a relay, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Embodiments provide a transceiver [e.g., UE], wherein the transceiver is configured, in a network search mode [e.g., cell search mode or network search mode], to search for a presence indicator signal, the presence indicator signal indicating a presence of
a wireless [e.g., radio based] communication network [e.g., 5G/NR communication network], or
a cell of the wireless [e.g., radio based] communication network [e.g., 5G/NR communication network], or
a beam of a cell of the wireless [e.g., radio based] communication network [e.g., 5G/NR communication network],
   wherein the presence indicator signal is associated in frequency with a group [e.g., block] of channels used by the wireless communication network [e.g., for synchronization], the group of channels comprising at least two channels, wherein the transceiver is configured, upon detecting the presence indicator signal, to search for a synchronization signal [e.g., synchronization signal block, SSB] in one or more channels of the group of channels.

Embodiments provide a transceiver [e.g., UE], wherein the transceiver is configured, in a network search mode [e.g., cell search mode], to search for a presence indicator signal, the presence indicator signal indicating a presence of a wireless [e.g., radio based] communication network [e.g., 5G/NR communication network], wherein the presence indicator signal is associated in frequency with a group [e.g., block] of channels used by the wireless communication network [e.g., for synchronization], the group of channels comprising at least two channels, wherein the transceiver is configured, upon detecting the presence indicator signal, to search for a synchronization signal [e.g., synchronization signal block, SSB] in one or more channels of the group of channels.

In embodiments, the presence indicator signal is associated in time and frequency with a time-frequency area [e.g., resource grid], the time-frequency area comprising in the frequency domain the group of channels and defining in the time domain a time interval, wherein the transceiver is configured, upon detecting the presence indicator signal, to search for the synchronization signal in the one or more channels of the group of channels and in the time interval defined by the time-frequency area.

In embodiments, the group of channels is a group of synchronization frequency positions or a group of synchronization channels [e.g., defined by global synchronization channel numbers, GSCN].

In embodiments, the presence indicator signal comprises an information describing the group of channels.

For example, the presence indicator signal can comprise an information describing the group of channels, such as a group channel number/identifier, or an information describing the channels of the group of channels, such as channel numbers/identifiers or respective frequencies/frequency ranges.

In embodiments, the presence indicator signal is transmitted on a frequency or channel having a predefined or pre-configured [e.g., fixed] frequency relationship to the group of channels, wherein the transceiver is configured to determine the group of channels based on the frequency or channel on which the presence indicator signal is transmitted and the predefined or pre-configured frequency relationship between the frequency or channel of the presence indicator signal and the group of channels.

For example, the presence indicator signal can be transmitted on a center frequency or channel of the group of channels, or on a n-th channel of the group of channels, such as a first or last channel of the group of channels, or on every k-th channel of the group of channels, or on all channels of the group of channels, or on a specific channel not necessarily being aligned with the channels of the group of channel.

In embodiments, the transceiver is configured to synchronize to the wireless communication network [e.g., to a cell of the wireless communication network] based on the synchronization signal [e.g., synchronization signal block, SSB].

In embodiments, the transceiver is configured to transmit a wake-up signal [e.g., to a base station the wireless communication network] in response to detecting the presence indicator signal, wherein the transceiver is configured to search for the synchronization signal after transmitting the wake-up signal.

In embodiments, the transceiver is configured, in case that the presence indicator signal is not detected [e.g., within a predefined time span], to search for another presence indicator signal that is associated with another group of channels.

In embodiments, the presence indicator signal carries data content [e.g., one or more bits].

In embodiments, the presence indicator signal carries the data content by means of one or more synchronization sequences included in the presence indicator signal, wherein the synchronization sequences are selected out of a plurality of different synchronization sequences in dependence on the data content to be transmitted, each of the different synchronization sequences being associated with different data content, wherein the transceiver is configured to determine the data content based on the one or more synchronization sequences included in the presence indicator signal.

In embodiments, the data content comprises an information describing a mode of operation [e.g., energy saving mode or normal operation mode] of a base station of the wireless communication network, wherein the transceiver is configured to adjust a time interval [e.g., of the time-frequency area] used for searching for a synchronization signal in dependence on the mode of operation of the base station, and/or wherein the transceiver is configured to transmit a wake-up signal prior to searching for a synchronization signal in dependence on the mode of operation of base station.

In embodiments, the data content comprises an information describing on which channel or channels of the block of channels a synchronization signal is transmitted, wherein the transceiver is configured to search for a synchronization signal on the channel or channels described by the information.

In embodiments, the data content comprises an information describing a [e.g., relative or absolute] time at which the synchronization signal is transmitted or a [e.g., relative or absolute] time interval [e.g., of the time-frequency area] in which the synchronization signal is transmitted, wherein the transceiver is configured to search for the synchronization signal at the time or within the time interval described by the information.

In embodiments, the transceiver is configured to, in a background search mode or handover/cell reselection mode, to search for another presence indicator signal that is associated with another block of channels [e.g., of the same or of another cell] of the wireless communication system.

In embodiments, the transceiver is configured to search, upon detecting the other presence indicator signal, to search for a synchronization signal [e.g., synchronization signal block] in one or more channels of the other group of channels.

In embodiments, the transceiver is configured to detect a primary synchronization signal that is repeated for a predefined number of symbols in a row as presence indicator signal.

In embodiments, the transceiver is configured to detect a primary synchronization signal that is transmitted at a frequency position that does not coincide with a frequency position of a conventional synchronization signal as presence indicator signal.

In embodiments, the transceiver is configured to detect a primary synchronization signal having another cell ID as presence indicator signal.

In embodiments, the network search mode includes or is a cell search mode.

In embodiments, the presence indicator signal comprises a synchronization signal block, SSB [e.g., non-cell defining SSB (or cell defining SSB)].

In embodiments, wherein the synchronization signal comprises a synchronization signal block, SSB [e.g., cell defining SSB (or non-cell defining SSB)].

In embodiments, the presence indicator signal comprises a synchronization signal block, SSB, wherein the synchronization signal comprises [e.g., or is] a tracking reference signal.

In embodiments, the transceiver is configured to transmit a wake-up signal [e.g., to a base station the wireless communication network; e.g. to a base station of a PCell or SCell], wherein the transceiver is configured to search for the presence indicator signal and/or the synchronization signal after transmitting the wake-up signal.

In embodiments, the presence indicator signal is transmitted using a presence indicator signal beam [e.g., beamforming], wherein the presence indicator signal that is transmitted using said presence indicator signal beam is associated with one or more synchronization signal beams using which one or more synchronization signals are transmitted.

In embodiments, the transceiver is configured to receive the presence indicator signal that is transmitted using the presence indicator signal beam using a spatial filter, wherein the transceiver is configured to receive the synchronization signal that is transmitted using a specific synchronization signal beam using the same spatial filter or a spatial filter derived therefrom.

In embodiments, the synchronization signal comprises a simplified synchronization signal block [e.g., comprising [or consisting only of] a primary synchronization signal and/or secondary synchronization signal].

In embodiments, the presence indicator signal comprises a simplified synchronization signal block [e.g., comprising [or consisting only of] a primary synchronization signal and/or secondary synchronization signal].

In embodiments, the transceiver is configured to receive the synchronization signal by searching for a physical broadcast channel.

In embodiments, the transceiver is configured to transmit a wake-up signal [e.g., uplink signal] in response to a reception of the simplified synchronization signal block, wherein the transceiver is configured to search for the physical broadcast channel in response to transmitting the wake-up signal.

In embodiments, the presence indicator signal or one or more resources using which the presence indicator signal is transmitted are associated with one or more resources [e.g., a time-frequency grid] in which a base station of the wireless communication network accepts the transmission of the wake-up signal.

In embodiments, the presence indicator signal comprises an information describing the one or more resources using which the synchronization signal is transmitted.

In embodiments, the presence indicator signal comprises a discovery reference signal.

In embodiments, the synchronization signal comprises a discovery reference signal.

In embodiments, the transceiver is configured to transmit a wake-up signal in response to a reception of the discovery reference signal, wherein the transceiver is configured to search for [e.g., and/or receive] a synchronization signal block in response to transmitting the wake-up signal.

In embodiments, the presence indicator signal or one or more resources using which the presence indicator signal is transmitted are associated with one or more resources [e.g., a time-frequency grid] in which a base station of the wireless communication network accepts the transmission of the wake-up signal.

In embodiments, the presence indicator signal and/or the synchronization signal comprises an information describing the one or more resources using which the synchronization signal block is transmitted.

In embodiments, the transceiver is configured to receive the presence indicator signal from a secondary cell, wherein the transceiver is configured to receive a synchronization signal block of a primary cell or anchor carrier as synchronization signal, or wherein the transceiver is configured to receive a tracking reference signal from a target cell.

In embodiments, the transceiver is configured to transmit a wake-up signal in response to a reception of the presence indicator signal, wherein the transceiver is configured to receive the synchronization signal block or tracking reference signal in response to a reception of the wake-up signal.

In embodiments, the presence indicator signal or one or more resources using which the presence indicator signal is transmitted are associated with one or more resources [e.g., a time-frequency grid] in which a base station of the wireless communication network accepts the transmission of the wake-up signal.

In embodiments, the presence indicator signal and/or the synchronization signal comprises an information describing the one or more resources using which the synchronization signal block or tracking reference signal is transmitted.

In embodiments, the transceiver is configured to receive a system information block [e.g., SIB-1] in response to a reception of a synchronization signal block as synchronization signal.

In embodiments, the transceiver is configured to receive the system information block from a primary cell or on an anchor carrier.

In embodiments, the transceiver is configured to transmit a wake-up signal and to receive the system information block in response to a reception of the wake-up signal.

Further embodiments provide a base station of a wireless [e.g., radio based] communication network [e.g., 5G/NR communication network], wherein the base station is configured to transmit a presence indicator signal [e.g., system presence indicator], the presence indicator signal indicating a presence of
the wireless communication network, or
or a cell of the wireless communication network, or
or a beam of a cell of the wireless communication network,
   wherein the presence indicator signal is associated in frequency with a group of frequencies used by the wireless communication network for transmitting one or more synchronization signals [e.g., synchronization signal blocks, SSB], the group of channels comprising at least two channels.

Further embodiments provide a base station of a wireless [e.g., radio based] communication network [e.g., 5G/NR communication network], wherein the base station is configured to transmit a presence indicator signal [e.g., system presence indicator], the presence indicator signal indicating a presence of the wireless communication network, wherein the presence indicator signal is associated in frequency with a group of frequencies used by the wireless communication network for transmitting one or more synchronization signals [e.g., synchronization signal blocks, SSB], the group of channels comprising at least two channels.

In embodiments, the presence indicator signal is associated in time and frequency with a time-frequency area [e.g., resource grid], the time-frequency area comprising in the frequency domain the group of channels and defining in the time domain a time interval.

In embodiments, the group of channels is a group of synchronization frequency positions or a group of synchronization channels [e.g., defined by global synchronization channel numbers, GSCN].

In embodiments, the presence indicator signal comprises an information describing the group of channels.

For example, the presence indicator signal can comprise an information describing the group of channels, such as a group channel number/identifier, or an information describing the channels of the group of channels, such as channel numbers/identifiers or respective frequencies/frequency ranges.

In embodiments, the presence indicator signal is transmitted on a frequency or channel having a predefined or pre-configured [e.g., fixed] frequency relationship to the group of channels.

For example, the presence indicator signal can be transmitted on a center frequency or channel of the group of channels, or on a n-th channel of the group of channels, such as a first or last channel of the group of channels, or on every k-th channel of the group of channels, or on all channels of the group of channels, or on a specific channel not necessarily being aligned with the channels of the group of channel.

In embodiments, the base station is configured to transmit the synchronization signal in the one or more channels of the group of channels.

In embodiments, the synchronization signal is transmitted by another base station in the one or more channels of the group of channels.

In embodiments, the synchronization signal is transmitted in response to a wake-up signal.

In embodiments, the base station is configured to transmit the presence indicator signal periodically.

For example, the base station can be configured to transmit the presence indicator signal every 80 ms or 160 ms.

In embodiments, a periodicity of the transmission of the presence indicator signal is different [e.g., larger] than a periodicity of a transmission of a synchronization signal [e.g., synchronization signal block, SSB].

For example, the presence signal indicator period may be configured differently than SSB period. It can even have two correspondences. For example, SSB on macrocell 20 ms, SSB on femtocell 160 ms and SPI transmitted by macrocell 80 ms, corresponding to both SSBs.

In embodiments, a number of different channels of frequencies on which the presence indicator signal is transmitted is smaller than a number of channels on which the synchronization signal [e.g., synchronization signal block, SSB] is transmitted.

In embodiments, the base station is configured to transmit the presence indicator signal only in an energy saving mode.

In embodiments, the base station is configured, in the energy saving mode, to not transmit synchronization signals.

In embodiments, wherein the base station is configured, in the energy saving mode, to only transmit a synchronization signal on demand [e.g., in response to a reception of a wake-up signal].

In embodiments, wherein the base station is configured, in the energy saving mode, to transmit synchronization signals with a larger period [e.g. less often] when compared to a normal operation mode.

In embodiments, the presence indicator signal comprises an information describing a current operation mode [e.g., energy saving mode or normal operation mode] of the base station.

In embodiments, the base station is configured to change a configuration [e.g., periodicity] of the transmission of the presence indicator signal in dependence on a condition of the cell or in response to a reception of wake-up signal.

In embodiments, the presence indicator signal carries data content.

In embodiments, the presence indicator signal carries the data content by means of one or more selected synchronization sequences included in the presence indicator signal, wherein the selected synchronization sequences are selected out of a plurality of different synchronization sequences in dependence on the data content to be transmitted, each of the different synchronization sequences being associated with different data content.

In embodiments, the data content comprises an information describing a mode of operation [e.g., energy saving mode or normal operation mode] of the base station.

In embodiments, the data content comprises an information describing on which channel or channels of the block of channels a synchronization signal is transmitted.

In embodiments, the data content comprises an information describing a [e.g., relative or absolute] time at which the synchronization signal is transmitted or a [e.g., relative or absolute] time interval in which the synchronization signal is transmitted.

In embodiments, the base station is configured to transmit a coordination information to one or more other base stations of the wireless communication system for coordinating the transmission of presence indicator signals and/or synchronization signals.

In embodiments, the base station is configured to receive, from another base station of the wireless communication system, a coordination information for coordinating the transmission of presence indicator signals and/or synchronization signals, wherein the base station is configured to adjust a transmission of the presence indicator signal and/or a transmission of the synchronization signal based on the coordination information.

In embodiments, the coordination information describes one or more out of
an operation mode [e.g., energy saving mode or normal operation mode],
transmission instances and/or a periodicity of a transmission of the presence indicator signal,
an absolute timing information for synchronizing transmission of presence indicator signals and/or synchronization signals,
transmission instances and/or a periodicity of a transmission of synchronization signals,
a request for transmitting the presence indicator signal,
a request for transmitting synchronization signals.

In embodiments, the base station is configured to transmit the presence indicator signal using beam sweeping.

In embodiments, the base station is configured to transmit the presence indicator signal using a number of beams that is smaller than a number of beams used for transmitting synchronization signals.

In embodiments, the base station is configured to transmit the presence indicator signal using a power spectral density that is higher than a power spectral density used for transmitting synchronization signals.

In embodiments, the base station is configured to use a coding scheme for transmitting the presence indicator signal.

In embodiments, the base station is configured to use space-time-frequency block codes for transmitting the presence indicator signal.

In embodiments, the base station is configured to transmit a primary synchronization signal that is repeated for a predefined number of symbols in a row as presence indicator signal.

In embodiments, the base station is configured to transmit a primary synchronization signal at a frequency position that does not coincide with a frequency position of a conventional synchronization signal as presence indicator signal.

In embodiments, the presence indicator signal comprises a synchronization signal block, SSB [e.g., non-cell defining SSB (or cell defining SSB)].

In embodiments, the synchronization signal comprises a synchronization signal block, SSB [e.g., cell defining SSB (or non-cell defining SSB)].

In embodiments, the presence indicator signal comprises a synchronization signal block, SSB, wherein the synchronization signal comprises [e.g., or is] a tracking reference signal.

In embodiments, the base station is configured to receive a wake-up signal [e.g., to a base station the wireless communication network; e.g. to a base station of a PCell or SCell], wherein the base station is configured to transmit or to control another base station to transmit the presence indicator signal and/or the synchronization signal in response to receiving the wake-up signal.

In embodiments, the base station is configured to transmit the presence indicator signal using a presence indicator signal beam [e.g., beamforming], wherein the base station is configured to transmit one or more synchronization signals using one or more synchronization signal beams, wherein the presence indicator signal beam is associated with one synchronization signal beam of the one or more synchronization signal beams.

In embodiments, the synchronization signal comprises a simplified synchronization signal block [e.g., comprising [or consisting only of] a primary synchronization signal and/or secondary synchronization signal].

In embodiments, the presence indicator signal comprises a simplified synchronization signal block [e.g., comprising [or consisting only of] a primary synchronization signal and/or secondary synchronization signal].

In embodiments, the base station is configured to receive a wake-up signal [e.g., uplink signal], wherein the base station is configured to transmit a physical broadcast channel in response to the reception of the wake-up signal.

In embodiments, the presence indicator signal or one or more resources using which the presence indicator signal is transmitted are associated with one or more resources [e.g., a time-frequency grid] in which the base station accepts the transmission of the wake-up signal.

In embodiments, the presence indicator signal comprises an information describing the one or more resources using which the synchronization signal is transmitted.

In embodiments, the presence indicator signal comprises a discovery reference signal.

In embodiments, the synchronization signal comprises a discovery reference signal.

In embodiments, the base station is configured to receive a wake-up signal, wherein the base station is configured to transmit a synchronization signal block in response to the reception of the wake-up signal.

In embodiments, the presence indicator signal or one or more resources using which the presence indicator signal is transmitted are associated with one or more resources [e.g., a time-frequency grid] in which the base station accepts the transmission of the wake-up signal.

In embodiments, the presence indicator signal and/or the synchronization signal comprises an information describing the one or more resources using which the synchronization signal block is transmitted.

In embodiments, the base station is configured to transmit a synchronization signal block or tracking reference signal.

In embodiments, the base station is configured to receive a wake-up signal, wherein the base station is configured to transmit the synchronization signal block or tracking reference signal in response to a reception of the wake-up signal.

In embodiments, the presence indicator signal or one or more resources using which the presence indicator signal is transmitted are associated with one or more resources [e.g., a time-frequency grid] in which the base station accepts the transmission of the wake-up signal.

In embodiments, the presence indicator signal and/or the synchronization signal comprises an information describing the one or more resources using which the synchronization signal block or tracking reference signal is transmitted.

In embodiments, the base station is configured to transmit or to control another base station to transmit a system information block [e.g., SIB-1] in response to a reception of a wake-up signal.

Further embodiments provide a wireless [e.g., radio based] communication network, comprising a transceiver as described herein and a base station as described herein.

Further embodiments provide a transceiver [e.g., UE], wherein the transceiver is configured, in a search mode [e.g., cell search mode, network search mode], to search for a presence indicator signal, the presence indicator signal indicating a presence of a wireless [e.g., radio based] communication network [e.g., 5G/NR communication network], wherein the presence indicator signal is associated in frequency with a group [e.g., block] of channels used by the wireless communication network [e.g., for synchronization], the group of channels comprising at least two channels, wherein the transceiver is configured, upon detecting the presence indicator signal, to search for a broadcast signal [e.g., physical broadcast channel, PBCH] in one or more channels of the group of channels.

Further embodiments provide a base station of a wireless [e.g., radio based] communication network [e.g., 5G/NR communication network], wherein the base station is configured to transmit a presence indicator signal [e.g., system presence indicator], the presence indicator signal indicating a presence of the wireless communication network, wherein the presence indicator signal is associated in frequency with a group of frequencies used by the wireless communication network for transmitting one or more synchronization signals [e.g., synchronization signal blocks, SSB], the group of channels comprising at least two channels.

In embodiments, the base station is configured to transmit a broadcast signal [e.g., physical broadcast channel, PBCH] in one or more channels of the group of channels.

Further embodiments provide a transceiver [or first transceiver; e.g., UE], wherein the transceiver is configured, in a search mode [e.g., discovery mode], to search for a presence indicator signal, the presence indicator signal indicating a presence of another transceiver [e.g., receiving UE], wherein the presence indicator signal is associated in frequency with a group [e.g., block] of channels used by the second transceiver [e.g., for synchronization], the group of channels comprising at least two channels, wherein the first transceiver is configured, upon detecting the presence indicator signal associated in frequency with the group [e.g., block] of channels used by the second transceiver, to search for a synchronization signal [e.g., sidelink synchronization signal block, SSB or sidelink control information, SCI] in one or more channels of the group of channels used by the other transceiver.

In embodiments, the transceiver and/or the other transceiver are configured to operate in a sidelink scenario [e.g., and to search for the presence indicator signal in the sidelink scenario].

In embodiments, the synchronization signal is a sidelink synchronization signal block, SSB or a sidelink control information, SCI.

Further embodiments provide another transceiver [or second transceiver; e.g., UE], wherein the other transceiver is configured to transmit a presence indicator signal [e.g., system presence indicator], the presence indicator signal indicating a presence of the other transceiver, wherein the presence indicator signal is associated in frequency with a group [e.g., block] of channels used by the second transceiver [e.g., for synchronization], the group of channels comprising at least two channels.

In embodiments, the transceiver and/or the other transceiver are configured to operate in a sidelink scenario [e.g., and to search for the presence indicator signal in the sidelink scenario].

In embodiments, the synchronization signal is a sidelink synchronization signal block, SSB or a sidelink control information, SCI.

Further embodiments provide a method for operating a transceiver [e.g., UE]. The method comprises a step of searching, in a network search mode, for a presence indicator signal, the presence indicator signal indicating a presence of
a wireless communication network, or
a cell of the wireless [e.g., radio based] communication network [e.g., 5G/NR communication network], or
a beam of a cell of the wireless [e.g., radio based] communication network [e.g., 5G/NR communication network],
   wherein the presence indicator signal is associated in frequency with a group [e.g., block] of channels used by the wireless communication network, the group of channels comprising at least two channels. Further, the method comprises a step of searching, upon detecting the presence indicator signal, for a synchronization signal [e.g., synchronization signal block, SSB] in one or more channels of the group of channels.

Further embodiments provide method for operating a transceiver [e.g., UE]. The method comprises a step of searching, in a network search mode, for a presence indicator signal, the presence indicator signal indicating a presence of a wireless communication network, wherein the presence indicator signal is associated in frequency with a group [e.g., block] of channels used by the wireless communication network, the group of channels comprising at least two channels. Further, the method comprises a step of searching, upon detecting the presence indicator signal, for a synchronization signal [e.g., synchronization signal block, SSB] in one or more channels of the group of channels.

Further embodiments provide a method for operating a base station of a wireless [e.g., radio based] communication network [e.g., 5G/NR communication network]. The method comprises a step of transmitting a presence indicator signal [e.g., system presence indicator], the presence indicator signal indicating a presence of
the wireless communication network, or
or a cell of the wireless communication network, or
or a beam of a cell of the wireless communication network,
   wherein the presence indicator signal is associated in frequency with a group of channels used by the wireless communication network for transmitting one or more synchronization signals [e.g., synchronization signal blocks, SSB], the group of channels comprising at least two channels.

Further embodiments provide method for operating a base station of a wireless [e.g., radio based] communication network [e.g., 5G/NR communication network]. The method comprises a step of transmitting a presence indicator signal [e.g., system presence indicator], the presence indicator signal indicating a presence of the wireless communication network, wherein the presence indicator signal is associated in frequency with a group of channels used by the wireless communication network for transmitting one or more synchronization signals [e.g., synchronization signal blocks, SSB], the group of channels comprising at least two channels.

Further embodiments provide a method for operating a transceiver [e.g., UE]. The method comprises a step of searching, in a search mode, for a presence indicator signal, the presence indicator signal indicating a presence of a wireless communication network, wherein the presence indicator signal is associated in frequency with a group [e.g., block] of channels used by the wireless communication network, the group of channels comprising at least two channels. Further, the method comprises a step of searching, upon detecting the presence indicator signal, for a broadcast signal [e.g., physical broadcast channel, PBCH] in one or more channels of the group of channels.

Further embodiments provide a method for operating a base station of a wireless [e.g., radio based] communication network [e.g., 5G/NR communication network]. The method comprises a step of transmitting a presence indicator signal [e.g., system presence indicator], the presence indicator signal indicating a presence of the wireless communication network, wherein the presence indicator signal is associated in frequency with a group of channels used by the wireless communication network for transmitting one or more synchronization signals [e.g., synchronization signal blocks, SSB], the group of channels comprising at least two channels. In embodiments, the method further comprises a step of transmitting a broadcast signal [e.g., physical broadcast channel, PBCH] in one or more channels of the group of channels.

Further embodiment provide a method for operating a transceiver [e.g., UE]. The method comprises a step of searching, in a search mode [e.g., discovery mode], for a presence indicator signal, the presence indicator signal indicating a presence of another transceiver [e.g., receiving UE], wherein the presence indicator signal is associated in frequency with a group [e.g., block] of channels used by the second transceiver [e.g., for synchronization], the group of channels comprising at least two channels. The method further comprises a step of searching, upon detecting the presence indicator signal associated in frequency with the group [e.g., block] of channels used by the second transceiver, for a synchronization signal [e.g., sidelink synchronization signal block, SSB or sidelink control information, SCI] in one or more channels of the group of channels used by the other transceiver.

Further embodiment provide a method for operating an other transceiver [e.g., UE]. The method comprises a step of transmitting a presence indicator signal [e.g., system presence indicator], the presence indicator signal indicating a presence of the other transceiver, wherein the presence indicator signal is associated in frequency with a group [e.g., block] of channels used by the second transceiver [e.g., for synchronization], the group of channels comprising at least two channels.

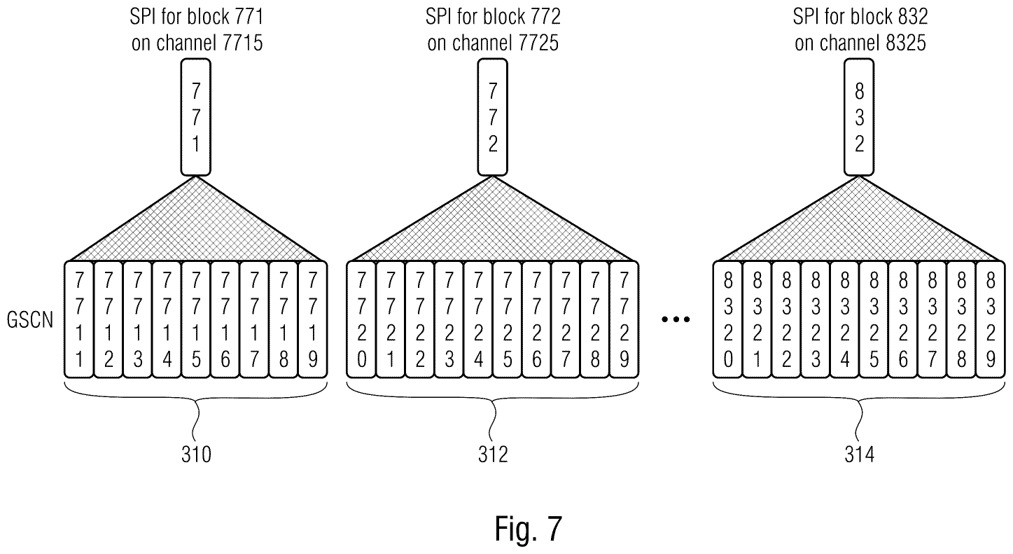

In accordance with embodiments, a separate signal is defined with the sole purpose to indicate the presence of a cellular system (e.g., 5G NR) in a block of RF channels. This signal is herein referred as a system presence indicator (SPI). This signal is transmitted to guide UEs on a faster ICS, thus the method is here named as network-guided ICS. The concept is illustrated in FIG. 7.

Specifically, FIG. 7 shows a schematic representation of a grouping of channels on the synchronization raster in blocks (or groups) 310, 312, 314 of up to ten frequencies (global synchronization channel number, GSCN). Thereby, in the example shown in FIG. 7, the SPI corresponds to all GSCNs of the block. As shown in FIG. 7, the potential SSB locations are grouped in blocks of 10 to facilitate comprehension but any granularity should be possible. Then, for example, if an SPI is transmitted for the block 772, it means that at least one of the frequencies/channels defined by the global synchronization channel numbers (GSCN) 7720-7729 contain an SSB.

In embodiments, the SPI is broadcast by a BS and is detected by a UE. If the UE receives an SPI, typically the UE should proceed by searching channels within that block (e.g., of channels/frequencies), as it is now sure of the presence of SSBs in that block. If the UE does not receive a SPI it may skip searching SSBs on that channel block and instead search for SPI on other blocks. The described mechanism will increase the probability that a suitable cell will be found more quickly, because the first step of the search is done block by block and only within the block the UE needs to search on all possible positions.

As SPI is a new mechanism, for a long time there will be need for co-existence of deployments of networks which transmit SPI and networks which don't. The UEs should be able to access and find either of them. As a fallback mechanism, the UE may also come back to a block again to perform a regular cell search (channel by channel), for example, if the network-guided ICS fails on all blocks. This fallback mechanism would allow newer UEs supporting SPI to access older networks which do not broadcast SPI.

In embodiments, if a UE detects SPI but it does not detect any SSB on the corresponding block, this should be regarded as a malicious node attack or an incompatible system. In either case, the UE should blacklist this block for a certain time.

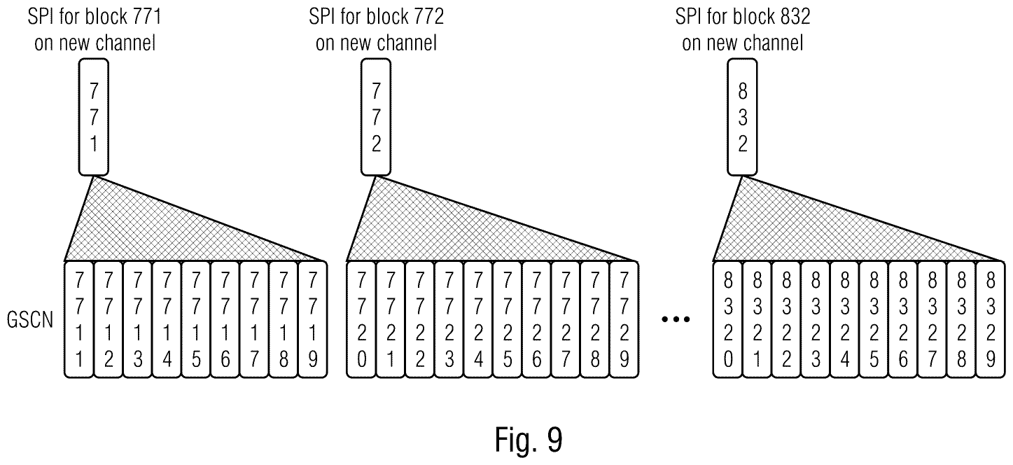

In embodiments, the SPI can be defined to be only potentially present in a small subset of the channels available for SSBs, for example every 8^{th}, 10^{th} (as shown in FIG. 7) or 16^{th} positions on the synchronization raster. In this way, to find an SPI the UE need to perform detection on less positions than to detect an SSB. As an example, FIG. 7 shows the band n77 which starts at GSCN 7711 and finishes at 8329. Note that it is not always possible to have all blocks exactly with the target granularity. Also in this example the SPI is centered on the GSCNs with ending five. Many other definitions are possible, as for example:
SPI is centered on first GSCN of the block,.
SPI is centered on last GSCN of the block,.
SPI is transmitted in all the positions of the block,.
SPI is transmitted every k-th position of the block,.
SPI has newly specific channels not corresponding to the GSCNs (new raster) (see FIG. 9).

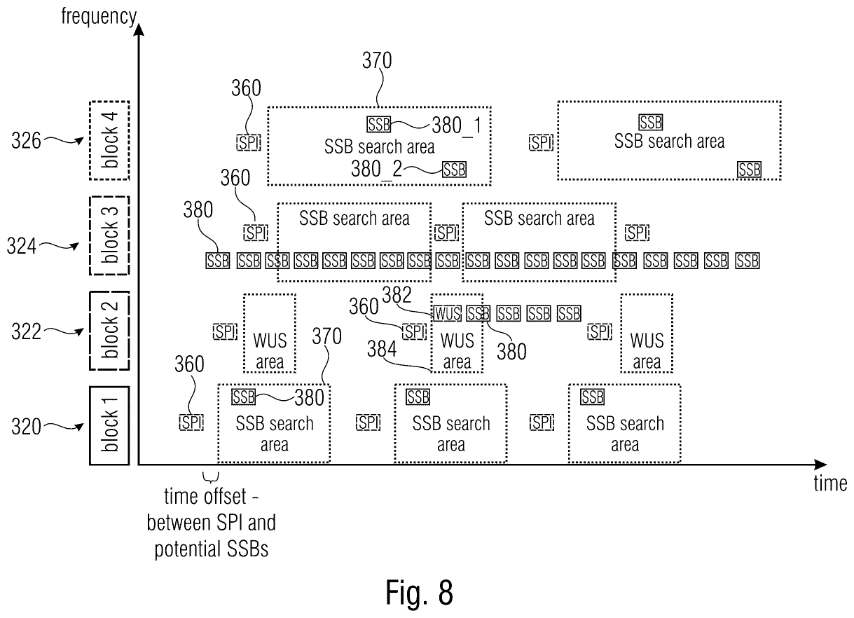

In addition to being associated with a block of frequencies, the SPI will typically be associated with a time interval. For example, the SPI presence may be interpreted by a UE as a signal indicating that at least one SSB should be detectable within the next T ms (e.g., T=80 ms or 160 ms) in the given frequency block. This concept, along with further deployment options is illustrated in FIG. 8. The SPI should be typically send periodically. The time interval to which a SPI corresponds may be the same as the period or also it may be set independently.

Specifically, FIG. 8 shows a schematic representation of several SPI deployment options. On frequency block one 320, the SPIs 360 correspond to a time vs frequency blocks or time-frequency areas 370, in which a SSBs 380 are transmitted. On frequency block two 322, the SPIs 360 are broadcast, but SSBs 380 are only transmitted on demand, i.e. the UE needs to send a wake-up signal 382 (e.g., in a wake-up time-frequency area 384) to activate SSBs 380. On frequency block three 324, both SPIs 360 and SSBs 380 are broadcast. On frequency block four 326, more than one SSBs 380_1 and 380_2 (cell) is present within the block or time frequency area 370 signaled by SPI 360.

In FIG. 8, block one 320 and block four 326 illustrate that an SPI 360 is associated to a certain time-frequency area (e.g., time-frequency resource grid) 370 where the UE should search for SSBs 380. Namely, the presence of SPI signals 360 indicate that the UE will be able to find further synchronization signals (SSBs) 3580 within the corresponding time and frequency interval 370. An offset between SPI 360 and the search area 370 may apply such that the UE has a processing time and/or can switch frequency and bandwidth configurations. The search area 370 may be frequency-dependent (specified for each band, subcarrier spacing or block). The search area 370 may also be coded into the SPI 360. This is illustrated in the difference between block one 320 and block four 326.

Another deployment scenario is illustrated in FIG. 8, block two 322. Only SPIs 360 are broadcast and SSBs 380 can only be broadcast on demand. For this reason the UE needs to request SSB transmission and need to send an uplink signal such as a wake-up signal (WUS) 382 in order for that cell knowing that it needs also to transmit SSBs 380. In this case the SPI 360 corresponds to a certain time-frequency grid 384 where WUS 382 may be accepted. In this scenario it is particularly beneficial to have in the SPI 360 some identification of the frequencies which contain SSBs 380 to limit the time-frequency search grid. This is to avoid that the UE need to send WUS 382 on all positions of the block. Such information coding on SPI is further specified in section 2. Alternatively, the WUS 382 could be sent to another cell which then informs the target cell via X2/Xn.

In deployments supporting a large number of legacy UEs (UEs which do not support SPI) or during high load times it can be beneficial to always broadcast both SPI and SSB as exemplified in FIG. 8, block three 324. In this case there will be scarcely any NES, but ICS can be made much faster.

The SPI 360 may also be used as a feature to direct UEs to an advantageous network layer. In this case, the lower priority network layers would not transmit SPI (it would be harder for the UE to find) whereas the higher priority layer would transmit SPI. In this way the load can be directed to such layer, which for example has higher capacity or higher RACH (Random Access Channel) capacity.

The solution may be applied also to LTE networks or 6G networks. In LTE there is no SSB concept, but PSS, SSS and PBCH are also present. In this case, the solution should be interpreted such that SPI indicates where to find PSS (and subsequently SSS and PBCH).

Subsequently, embodiments of the present invention are described in further detail.

### 1. Combining SPI With Network Energy Saving States

As described above, on the one hand the SPI should typically operate with a much larger frequency granularity than the synchronization raster. On the other hand, from network perspective, it may be desirable to have the SPI periodicity much larger than SSB periodicity to have energy savings. This period could be for example, every 80 ms or every 160 ms. Combining a sparser operation on frequency and time, the total ICS procedure time can be decreased while still enabling NES. For example, the proposed Network-guided ICS with SPI period of 80 ms and SPI positions on every 16^{th} GSCN can be compared with a legacy SSB ICS with 20 ms period and all possible positions. The longer period in time would indeed increase the search time by a factor of four while saving power. However, in frequency domain only 1/16 GSCNs have to be searched plus the ones corresponding to present SPIs, so that the total ICS time still may be almost four times faster while the network can save significant amounts of energy. In addition to that, the UE would also benefit from less battery consumption and less decodings.

In embodiments, the SPI transmission could be varied depending on the use case and deployment. Some possibilities to accomplish a NES use case are, for example:
The SPI is only transmitted if the cell is on energy saving mode (larger SSB period or absent SSBs). No SPI when the SSBs have regular period (20 ms or less).
SPI is always transmitted regardless of cell mode. Thereby,
   the SPI provides no indication of which mode the cell is (energy saving or regular mode), or
   the SPI uses a 1-bit indication to tell if the cell is energy saving or regular mode (see section 2 for discussion on transmitting data on SPI).

In embodiments, an energy saving mode can be, for example, that a cell transmits SSB with a large period, or that SSBs are only transmitted on-demand.

In embodiments, the SPI usage and configuration (e.g. periodicity) could be adapted based on different conditions, such as, for example:
traffic load of cell (over time period) threshold could be introduced, pre-defined periods for cell energy saving/pre-sleep state/mode or wake-up state/mode,
a kind of wake-up signal may change the configuration, e.g., stop SPI transmission and use “full SSBs” only, or accessing on-demand SSBs,.
once a cell is transitioning to this energy-saving state.

In embodiments, a neighbor cell may request normal SSB transmission from a cell in NES mode. For example, if no UE is in the NES cell, but UEs are in connected mode in a neighbor cell, this cell may trigger normal SSB operation in the NES cell to enable the UEs to detect this cell more reliably. This would be needed to anticipate or prepare for a possible handover to the NES cell. In case of UEs in idle mode this has to be extended to the whole tracking area. In other words, since only the tracking area is known to the network where an idle mode UE is located, all NES cells in the tracking area enter normal operation if this concept should be also supported for idle mode UEs.

### 2. Data transmission on SPI

A broadcast signal for easy detection may hardly carry data. However, certain techniques allow to transmit some essential information without imposing excessive complexity and detection time. For example, in 5G NR the PSS may contain three different sequences and SSS may contain 336 sequences. Together, they are used to convey the physical cell ID, out of 1008. Similar techniques may be used to transmit a few bits of information on SPI. In order to signal a certain value, a sequence or a set of sequences may be assigned a certain significance.

One example of important data which could be transmitted on SPI is whether the cell transmitting SPI is on energy saving mode or not. The UEs may behave accordingly. If the UE can determine from SPI that the cell is not on energy saving mode, a 20 ms periodicity is assumed by the UE and the legacy behavior of channel detection can be applied on each frequency. Conversely, if the SPI indicates the cell is on network energy saving mode a larger periodicity, e.g. 80 ms or 160 ms, is assumed and the UE will spend more time detecting the SSB on each channel.

Another usage of data (and sequences) could be to subdivide the channels of the frequency block to further speed up the ICS. As an example, in an SPI related to 16 channels, the SPI would be transmitted with one out of four different sequences to indicate whether the SSB is expected on the first four channels, channel 5-8, 9-12 or 13-16. In this way, after decoding the SPI the UE only needs to search for SSB in ¼ of the channels.

Another approach to introduce extra information on SPI is to divide the SPI into two signals: a synchronization signal of easy detection and another signal carrying SPI information. In this case, the SPI can carry more detailed information about the SSBs which can be found on the time-frequency block. Also, this may be used to enhance the ICS. The SPI could include information to identify where to find the SSB such as, for example.
frequency/band information and/or in combination with
timing information, e.g., at least one SSB should be detectable within the next T ms (e.g,. T=80 ms or 160 ms) in the given frequency block, and/or.
a defined time interval, e.g., to find the SSB from the SPI to given time interval or a start and end time interval, and/or.
a time/time difference when next full SSB will be transmitted and/or periodicity of SSB that may optionally be combined with information about time and/or frequency about the next SSB, and/or.
a frequency offset which indicates when the SPI refers to presence of SSBs in another frequency block. This may be used, for example to signal the SSB presence of another component carrier.

### 3. SPI and SSB Coordination Among GNBs

In accordance with embodiments, some coordination among gNBs can be useful in order to maximize network energy savings and at the same time maximize the possibility that the UE can perform successful ICS quickly.

In embodiments, gNBs may signal to other gNBs/eNBs on Xn/X2 interfaces in order to coordinate when SPI and SSBs are transmitted. For example, a gNB may send one or more messages containing at least one of the following fields:
An indication that the gNB is entering an energy saving mode.
An absolute or relative indication of when the gNB plans to transmit SPIs.
An absolute or relative indication of when the gNB plans to transmit SSBs.
A request that the other gNB takes over SPI and/or SSB transmission.
   As a response the other gNB may:
      Send an indication that the request was accepted.
      Send an indication that the request was rejected.
      Send a counter-proposal.

Such information may refer to a cell level or to a site level.

As shown in FIG. 8, block four 326, a single SPI may correspond to multiple frequencies/cells/systems, each signaling one SSB. Such multiple correspondence may be configured as a result of the negotiation among gNBs using the message(s) described above.

### 4. Information Usage on Handover/Cell Reselection and Background Cell Search

Even after successful ICS the UE may need to keep searching for more cells and systems (PLMNs and Stand-alone Non-Public Networks—SNPNs). That is called background search. SPIs can be used on background search on the same way as in ICS.

In addition to that, UEs need to discover and measure more cells as part of cell reselection or handover procedures. Cell reselection and handover rely on explicit signaling of the frequencies. When explicit signaling is present the UE can directly tune to such frequencies to discover where an SSB is present. Nonetheless, the SPI information can still be useful to acquire information about SSBs. For example, to avoid duplicate signaling the UE may extract timing information (SSB periodicity) from SPI while using the specific frequency from other messages (e.g., SIB 3, SIB 4, SIB 5, dedicated signaling). Using the information from SPI could be used to avoid adding SSB periodicity to all these other messages.

In embodiments, SPI transmission could also aid in selecting small and macro cells, depending on the configuration and network management. Small cells with SPI can be found easily in background cell search and potentially reduce UE power consumption while reducing “blind detection and decoding” of SSBs.

In embodiments, when a macro cell has SPI enabled and a small cell has regular SSB periodicity (less TX power than in macro cell), the UE can detect the small cell with regular periodicity and the macro cell via SPI transmission and NES enabled. Using assistance information in macro and or small cells whether SPI is enabled or not can further assist the UE to detect cells during ICS and/or background cell search.

### 5. Spatial Domain Processing and SPI Coverage

In 5G NR, the SSBs are often transmitted with beamforming to enable beam selection and enhanced coverage. Since an SPI indicates the system presence (e.g., where SSBs can be found), it is highly desirable that the SPI has at least the same coverage as SSB. There are several possibilities to reach the same coverage as SSB, as for example:
A beam sweeping also applies to SPI. Depending on beamforming type this has to be one beam after another over the time.
For the sake of NES, it could be beneficial to avoid or reduce the sweeping, to avoid a long SPI transmission time. Therefore it could be that SPI is transmitted with a single beam or less beams than SSB. But then the SPI coverage has to be recovered in a different way. For example:
   The SPI is transmitted with higher Power Spectral Density (PSD) than SSBs.
   The SPI uses some coding scheme to achieve more robust transmission and better coverage, such as repetition coding on time and/or frequency.
   The SPI uses Space-time-frequency block codes such as Alamouti codes to enhance coverage.
The SPI is transmitted from several cells and sites at the same time forming a Single Frequency Network (SFN). The synchronized transmission may be applicable to a small area or the whole network.

### 6. Reuse of Already Standardized Signals as SPI

Every time a new signal and/or waveform is standardized this adds up to the UE complexity. For this reason, it could be desirable to reuse already standardized signals as an SPI. This could avoid, for example, the need that the UE needs to implement one more correlator for SPI. One example is reusing PSS as SPI, since UEs need to implement PSS search anyway. However, if this reuse is done, the UEs need to be able to distinguish a PSS used to indicate an SPI from a PSS starting an SSB. This could be done for example by repeating the PSS some X symbols in a row. Then a single PSS would start a SSB, X PSSs in row mean SPI.

Another possibility to reuse PSS signal, but differentiate SPIs from SSBs, is to define a new raster where the frequency positions used for SPI do not correspond to existing positions for SSBs (GSCNs). This concept is illustrated in FIG. 9 where the new frequency position lie between first and second GSCN of the block. Specifically, FIG. 9 shows a schematic representation of a definition of a new frequency raster for SPIs, where SPI frequency positions are different from the GSCN/synchronization raster (e.g. an offset is applied), wherein similar to FIG. 7, the GSCN channels are grouped in blocks 310, 312, 314. In the case, where new frequency positions are used, PSS on the new position means SPI whereas PSS on GSCNs mean SSBs.

Another example of possible design is to reuse the synchronization signals for NB-IoT. They have been designed to be quite robust and experience extremely enhanced coverage.

### 7. Reusing SSBs as SPI in New Bands

The need to distinguish an existing signal (e.g., PSS in the previous section) come from legacy UEs. Legacy UEs would be confused, for example, if a PSS is not followed by an SSS, or if a PSS and a SSS is not followed by PBCH. As new bands are added over time to 5G NR and eventually to 6G, in accordance with embodiments, in this new bands the SSB period can be defined larger as in legacy bands (e.g., it is possible to define that in new bands the assumed SSB period is large). As the new band has no legacy UE which would be confused by the transmission of a sparse SSB, in accordance with embodiments, in such new band it is possible to reuse the whole SSB as an SPI. Namely, a SSB can be associated to a block of frequencies to speed up initial cell search and that SSB may point to another SSB in a different frequency of that block.

In embodiments, the SPI may be a NCD-SSB (NCD-SSB=non-cell defining SSB), whereas the other SSB may be a CD-SSB (CD-SSB=cell defining SSB). This may also be defined the other way around that an SSB as SPI is a CD-SSB but the other SSB is a NCD-SSB.

In a variation of this embodiment, it may be that enough synchronization can be achieved from the SSB which is used as an SPI and some other signal mark instead. This could be for example a TRS (TRS=tracking reference signal).

### 8. WUS Directly on Target Cell or Via Another Cell

Some embodiments described herein include the possibility to send a WUS as a step to restore a broadcast signaling, such as the SSB. As explained above, e.g., with respect to FIG. 8, a WUS can be sent directly to the target cell (e.g., where access occur) or alternatively, the WUS can be sent to another cell, which then informs the target cell, e.g., via X2/Xn. In accordance with embodiments, in this case the WUS may be received on a PCell, to re-activate a broadcast signaling of an SCell. In case PCell and SCell are co-located everything can be processed locally and there is no need for X2/Xn communication.

In embodiments, the SPI may be used as the synchronization signal for WUS.

### 9. Correspondence of SPI Beams to SSB Beams

Some implementations of gNBs with multiple antennas have beams which cover specific parts of the coverage area of the gNB. As described on section 5, the SPI may also be beamformed.

In some embodiments multiple SPIs may be sent, each on a different beam (direction).

In embodiments, a particular SPI may also be associated to specific SSB beams of a cell, within a wireless communication network. This may be achieved, for example, by restricting the time window offset to correspond only to a subset of the SSB beams in a SSB-burst. This may help the UE to use the same spatial filter used to find the SPI, in order to synchronize to the SSB beam.

In accordance with embodiments, the association of SPI to SSBs need not be one to one. In fact, in embodiments, less SPI beams than SSB beams can be used, to save energy and reduce overhead, but associate some SSBs to multiple SPIs in order to have some overlapped coverage of the different SPI beams. This may provide some margin on face of high mobility or varying radio conditions.

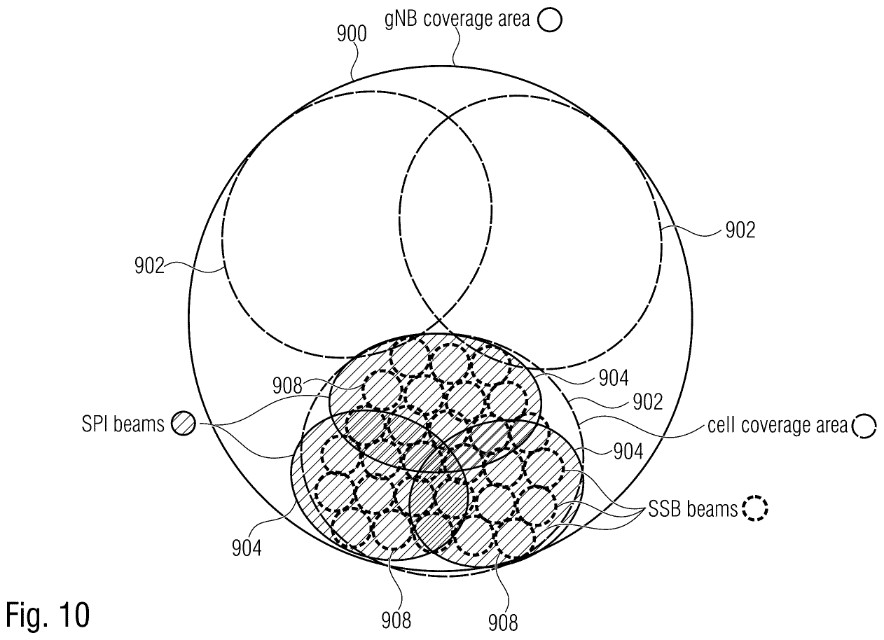

The concept of SPI beam to SSB beam correspondence is illustrated in FIG. 10.

Specifically, FIG. 10 is a schematic representation of a gNB coverage area 902, cell coverage areas 904 as well as within one of the cells an association of SPI beams 906 to SSB beams 908. As shown in FIG. 10, SPI beams 606 may be associated to SSB beams 908, typically with SPI beams 906 larger than SSB beams 908 and associated to multiple SSB beams 908. This correspondence does not need to be one to one. The same SSB beam may be associated to multiple SPI beams to provide some overlapping area between SPI beams.

### 10. Combining SPI With Simplified SSB

[6] defines a simplified SSB as an SSB, which only consists of transmission of PSS and SSS (e.g., like in LTE). This is an energy saving measure which can save the energy needed for PBCH transmission.

In embodiments, a simplified SSB may also be used as an SPI or in addition to an SPI. As described in the section 6 (“reuse of already standardized signals”), in some embodiments, the simplified SSB may be distinguished from complete SSBs, so that legacy UEs do not get confused. This may be accomplished by repeating PSS X times and SSS Y times, or using a new frequency raster for simplified SSBs.

In case the simplified SSB is to be used in addition to the SPI, the embodiment is very similar to the embodiments with regular SSBs, except that after reading SPI the UE should find a simplified SSB instead of a complete SSB.

In case the simplified SSB is to be used as an SPI, the procedures described in section 1 can still apply, but basically after reading the SPI (e.g., simplified SSB) instead of search for a further synchronization signal the UE needs to find the PBCH. The PBCH may be transmitted more infrequently than the simplified SSB, e.g., simplified SSBs are transmitted every 20 ms but PBCH only every 80 ms. Another approach is that a PBCH needs to be activated, for example, with signaling to another cell or a wake-up signal (WUS). For this reason the UE can request PBCH transmission and can send an uplink signal, such as a Wake-up Signal (WUS), in order for that cell to know that it needs also to transmit PBCH in addition to or regular SSB instead of the simplified SSB (SPI). In this case, the SPI may correspond to a certain time-frequency grid where WUS may be accepted by a gNodeB. In the scenario with PBCH in addition to simplified SSB it is particularly beneficial to have in the SPI some identification of the frequencies which contain PBCH to limit the time-frequency search grid. This is to avoid that the UE need to send WUS on all positions of the block. Such information coding on SPI is further specified on section 2.

### 11. Combining SPI With Discovery Reference Signals (DRS)

A discovery reference signal (DRS) is a signal which allows UEs to measure the received signal power of other cells for RRM purposes (e.g. handover decisions). It is used, for example, in LTE small cells in substitution to a PSS/SSS (the equivalent of SSB in LTE).

In embodiments, a DRS may also be used as an SPI or in addition to an SPI.

In case the DRS is to be used as an SPI, in embodiments, the same signal supports the SPI use case (for faster initial cell search) and the DRS use case (for RRM measurements). This is an advantageous embodiment if both are supported in order to avoid transmitting two signals. Also, DRS and SPI are both supposed to have long cycles (e.g., typically larger than SSB cycles) and therefore combining them is suitable and desirable.

In case the DRS is to be used in addition to the SPI, the embodiment is very similar to the embodiments with regular SSBs, except that after reading SPI the UE should find a DRS instead of a complete SSB.

In either case (e.g., DRS as SPI or additional to SPI), after the UE is able to track DRS the activation of SSB via WUS or signaling to another cell may follow. For example, only DRS/SPIs are broadcast, where SSBs can only be broadcast on demand. For this reason, the UE needs to request SSB transmission, for example, by sending an uplink signal, such as a wake-up signal (WUS), in order for that cell to know that it needs also to transmit SSBs. In this case, the DRS/SPI may correspond to a certain time-frequency grid where WUS may be accepted. In this scenario it is particularly beneficial to have in the DRS/SPI some identification of the frequencies which contain SSBs to limit the time-frequency search grid. This is to avoid that the UE need to send WUS on all positions of the block. Such information coding on DRS/SPI is further specified on section 2. Alternatively, the WUS could be sent to another cell which then informs the target cell via X2/Xn. This is further described in section 8, which also describes the case where WUS is sent on a PCell to activate SSB on a SCell locally without the need to communicate via X2/Xn

### 12. Combining SPI With SSB-Less and SSB On-Demand Operation

[6] defines a SSB-less operation as a case when a SCell (secondary cell) does not transmit SSB. This saves energy as SSBs are not transmitted in all cells, but only on a reduced number of cells (e.g. one cell). The main cell which transmits SSB may also be referred as anchor carrier/cell and would typically correspond to the PCell when CA is used (but not necessarily).

In case of SSB-less operation the procedures described in section 1 can still apply, but after finding SPI instead of synchronizing to SSB on the target cell, other synchronization signals may be considered, such as, for example,.
the SSB on PCell/anchor carrier/cell; and/or
TRS (TRS=tracking reference signal) on the target cell.

In embodiments, the SPI plus SSB-less operation may also be combined with SSB on demand. Only SSBs on anchor carrier are broadcast and SSBs on SSB-less cell can only be broadcast on demand. For this reason the UE may request SSB transmission on SSB-less cell, for example, by sending an uplink signal, such as a Wake-up Signal (WUS), in order for that cell knowing that it needs also to transmit SSBs. In this case the SI on anchor carrier/cell corresponds to a certain time-frequency grid where WUS may be accepted. In this scenario it is particularly beneficial to have in the SI in anchor carrier/cell some identification of the frequencies which contain SSBs to limit the time-frequency search grid. This is to avoid that the UE need to send WUS on all positions of the block. Alternatively, the WUS could be sent to another cell (e.g., the anchor cell) which activates the SSB on the SSB-less cell if they are co-located or informs the target cell via X2/Xn if they are not co-located. This is further described in section 8.

In embodiments, In fully SSB-less operation, after finding an SPI depending on the scenario it may be possible that the synchronization is achieved from the SSB in PCell instead of SCell.

### 13. Combining SPI With SIB-1-Less and SIB-1 On-Demand Operation

[6] defines a SIB-1-less operation as a case when a SCell (secondary cell) does not transmit SIB-1. This would typically be implemented as cells with SSB but no SIB-1, due to synchronization. This saves energy as SIB-1-s are not transmitted in all cells, but only on a reduced number of cells (e.g., one cell). The main cell which does carry SIB-1 may also be referred to as anchor carrier/cell and would typically correspond to the PCell when CA is used (but not necessarily).

An SPI may correspond to the anchor cell, to the SIB-1-less carrier or both. As long as SSBs are transmitted the same procedures described in section 1 can still apply.

In embodiments, after SSB decoding, the SIB-1 may be obtained according to different procedures. For example, in cross-carrier SIB-1 transmission, the SIB-1 for the target cell is transmitted on the anchor carrier instead of the SIB-1-less cell itself.

In case of SIB-1 on-demand, only SIB-1 associated to the anchor carrier/cell are broadcast and SIB-1s associated to the SIB-1-less cell can only be broadcast on-demand. For this reason the UE may request SIB-1 transmission on SIB-1-less cell, for example, by sending an uplink signal, such as a Wake-up Signal (WUS), in order for that cell knowing that it needs also to transmit SIB-1s. In this case the SI on anchor carrier/cell corresponds to a certain time-frequency grid where WUS may be accepted. In this scenario it is particularly beneficial to have in the SI in anchor carrier/cell some identification of the frequencies which contain SSBs to limit the time-frequency search grid. This is to avoid that the UE need to send WUS on all positions of the block. Alternatively, the WUS could be sent to another cell (e.g., the anchor cell) which activates the SIB-1 on the SIB-1-less cell if they are co-located or informs the target cell via X2/Xn if they are not co-located. This is further described in section 8.

### 14. Combining SPI to Sidelink Operation

In case of sidelink (SL) communication a UE is not searching for cells or networks but searching for other UEs on the vicinity. Still, the same concept as in SPI can be applied: a UE searches for an indicator signal which may be transmitted in a reduced number of RF channels, e.g., a new synchronization raster for V2X. After detecting the indicator signal, the UE can search for a synchronization signal in the frequencies associated to the presence indicator signal. In the case of sidelink the synchronization signal may be, for example, an S-SSB (S-SSB=sidelink SSB) or an SCI (SCI=sidelink control information).

### 15. Further Embodiments

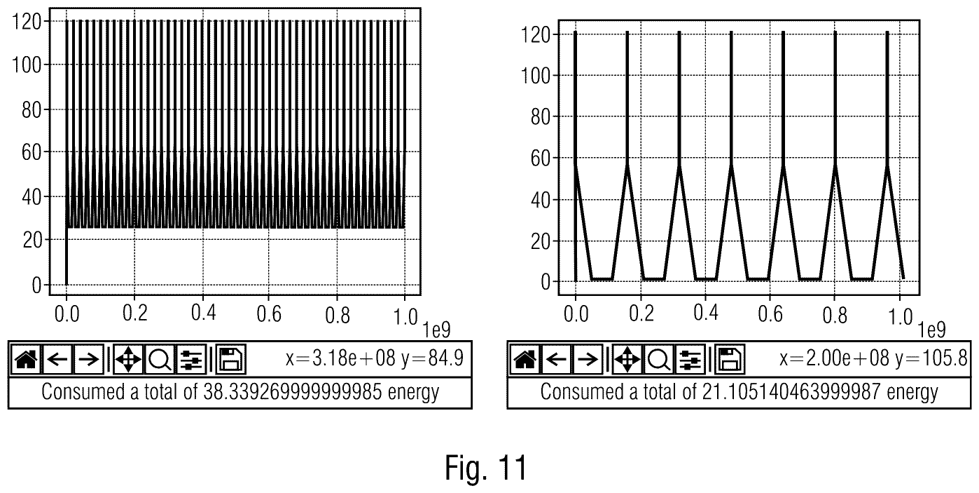

The ever-growing Network Energy Consumption is one of the most pressing issues for further development of mobile networks. Not by chance 3GPP is investigating on release-18 network energy saving techniques. Based on the initial contributions the most promising frontier is reducing the SSB frequency. FIG. 11 to right shows in a diagram a power consumption over time for one SSB burst every 20 ms, where FIG. 11 to the left shows in a diagram a power consumption over time for one SSB burst every 160 ms. The energy consumption is almost cut by half. However that creates a fundamental dilemma: long SSB interval means the cell is invisible on initial cell-search. One phrase on [4] kills most energy saving possibilities: “For initial cell selection, a UE may assume that half frames with SS/PBCH blocks occur with a periodicity of two frames.”

Therefore, in accordance with some embodiments, the initial cell-search is enhanced with the addition of a new “pre-SSB” signal, referred herein as system presence indicator, SPI, which indicates that at least one SSB will be present if the UE waits longer than 20 ms, i.e. a presence indicator for a cell in network energy saving mode.

In embodiments, SPI may replace SSB or in addition to SSB depending on use case/deployment.

In embodiments, the SPI raster can be much sparser (e.g., 10× or 16× sparser) (e.g., when compared to the SSB raster.

In embodiments, SPI may be a highly simplified signal, or a PSS. The bandwidth of a SPI can be smaller.

In embodiments, gNBs may coordinate sending SPI and SSBs via Xn interface.

Embodiments described herein allow for faster ICS. Part of this gain on ICS may be used to enable NES (which otherwise would imply very slow and unreliable ICS).

Embodiments makes the initial cell search of mobile communication systems much faster. Embodiments provide a new signal which indicates the system presence. The new signal may have a periodicity independent from other synchronization signals and because of that the signal can be fully adapted to fulfill new requirements on network energy saving.

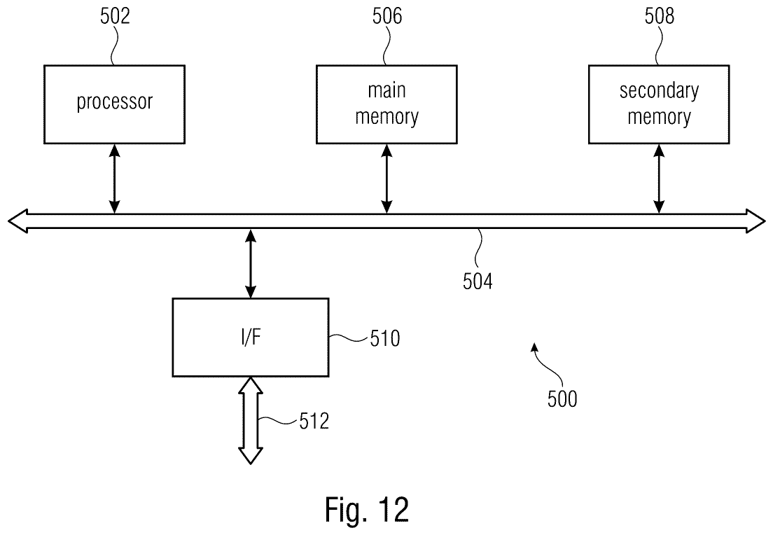

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a

PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### List of References

[1] TS 38.304 v17.0.0 NR; User Equipment (UE) procedures in idle mode and in RRC Inactive state
[2] TS 38.101-1 v17.6.0 NR; User Equipment (UE) radio transmission and reception; Part 1: Range 1 Standalone
[3] TS 38.101-2 v17.6.0NR; User Equipment (UE) radio transmission and reception; Part 2: Range 2 Standalone
[4] TS 38.213 v17.2.0 NR; Physical layer procedures for control
[5] TS 38.331 v17.1.0 NR; Radio Resource Control (RRC); Protocol specification
[6] TR 38.864 v1.0.0 Study on network energy savings for NR
[7] TS 24.368 Non-Access Stratum (NAS) configuration Management Object (MO)

### Abbreviations

3GPP third generation partnership project
ACK acknowledgement
AIM assistance information message
AMF access and mobility management function
BS base station
BWP bandwidth part
CA carrier aggregation
CC component carrier
CBG code block group
CBR channel busy ratio
CQI channel quality indicator
CSI-RS channel state information-reference signal
CN core network
D2D device-to-device
DAI downlink assignment index
DCI downlink control information
DL downlink
DRX discontinuous reception
FFT fast Fourier transform
FR1 frequency range one
FR2 frequency range two
GMLC gateway mobile location center
gNB evolved node B (NR base station)/next generation node B base station
GSCN global synchronization channel number
HARQ hybrid automatic repeat request
ICS initial cell search
IoT internet of things
LCS location services
LMF location management function
LPP LTE positioning protocol
LTE long-term evolution
MAC medium access control
MCR minimum communication range
MCS modulation and coding scheme
MIB master information block
NACK negative acknowledgement
NB node B
NES network energy saving
NR new radio
NTN non-terrestrial network
NW network
OFDM orthogonal frequency-division multiplexing
OFDMA orthogonal frequency-division multiple access
PBCH physical broadcast channel
P-UE pedestrian UE; not limited to pedestrian UE, but represents any UE with a need to save power, e.g., electrical cars, cyclists,
PC5 interface using the sidelink channel for D2D communication
PDCCH physical downlink control channel
PDSCH physical downlink shared channel
PLMN public land mobile network
PPP point-to-point protocol
PPP precise point positioning
PRACH physical random access channel
PRB physical resource block
PSFCH physical sidelink feedback channel
PSCCH physical sidelink control channel
PSSCH physical sidelink shared channel
PUCCH physical uplink control channel
PUSCH physical uplink shared channel
RAIM receiver autonomous integrity monitoring
RAN radio access networks
RAT radio access technology
RB resource block
RNTI radio network temporary identifier
RP resource pool
RRC radio resource control
RS reference symbols/signal
RTT round trip time
SBI service based interface
SCI sidelink control information
SI system information
SIB sidelink information block
SL sidelink
SPI system presence indicator
SSB synchronization signal block
SSR state space representations
TB transport block
TTI short transmission time interval
TDD time division duplex
TDOA time difference of arrival
TIR target integrity risk
TRP transmission reception point
TTA time-to-alert
TTI transmission time interval
UCI uplink control information
UE user equipment
UL uplink
UMTS universal mobile telecommunication system
V2x vehicle-to-everything
V2V vehicle-to-vehicle
V2I vehicle-to-infrastructure
V2P vehicle-to-pedestrian
V2N vehicle-to-network
V-UE vehicular UE
VRU vulnerable road user
WUS wake-up signal

1. Transceiver,
wherein the transceiver is configured, in a search mode, to search for a presence indicator signal, the presence indicator signal indicating a presence of
a wireless communication network, or
a cell of the wireless communication network, or
a beam of a cell of the wireless communication network,
wherein the presence indicator signal is associated in frequency with a group of channels used by the wireless communication network, the group of channels comprising at least two channels,
wherein the transceiver is configured, upon detecting the presence indicator signal, to search for a synchronization signal in one or more channels of the group of channels.

2. Transceiver as claimed in claim 1,
wherein the presence indicator signal is associated in time and frequency with a time-frequency area, the time-frequency area comprising in the frequency domain the group of channels and defining in the time domain a time interval,
wherein the transceiver is configured, upon detecting the presence indicator signal, to search for the synchronization signal in the one or more channels of the group of channels and in the time interval defined by the time-frequency area.

3. Transceiver as claimed in claim 1,
wherein the group of channels is a group of synchronization frequency positions or a group of synchronization channels.

4. Transceiver as claimed in claim 1,
wherein the presence indicator signal comprises an information describing the group of channels.

5. Transceiver as claimed in claim 1,
wherein the presence indicator signal is transmitted on a frequency or channel having a predefined or pre-configured frequency relationship to the group of channels,
wherein the transceiver is configured to determine the group of channels based on the frequency or channel on which the presence indicator signal is transmitted and the predefined or pre-configured frequency relationship between the frequency or channel of the presence indicator signal and the group of channels.

6. Transceiver as claimed in claim 1,
wherein the transceiver is configured to synchronize to the wireless communication network based on the synchronization signal.

7. Transceiver as claimed in claim 1,
wherein the transceiver is configured to transmit a wake-up signal in response to detecting the presence indicator signal,
wherein the transceiver is configured to search for the synchronization signal after transmitting the wake-up signal.

8. Transceiver as claimed in claim 1,
wherein the transceiver is configured, in case that the presence indicator signal is not detected, to search for another presence indicator signal that is associated with another group of channels.

9. Transceiver as claimed in claim 1,
wherein the presence indicator signal carries data content.

10. Transceiver as claimed in claim 9,
wherein the presence indicator signal carries the data content by means of one or more synchronization sequences included in the presence indicator signal, wherein the synchronization sequences are selected out of a plurality of different synchronization sequences in dependence on the data content to be transmitted, each of the different synchronization sequences being associated with different data content,
wherein the transceiver is configured to determine the data content based on the one or more synchronization sequences included in the presence indicator signal.

11. Transceiver as claimed in claim 9,
wherein the data content comprises an information describing a mode of operation of a base station of the wireless communication network,
wherein the transceiver is configured to adjust a time interval used for searching for a synchronization signal in dependence on the mode of operation of the base station,
and/or wherein the transceiver is configured to transmit a wake-up signal prior to searching for a synchronization signal in dependence on the mode of operation of base station.

12. Transceiver as claimed in claim 9,
wherein the data content comprises an information describing on which channel or channels of the block of channels a synchronization signal is transmitted,
wherein the transceiver is configured to search for a synchronization signal on the channel or channels described by the information.

13. Transceiver as claimed in claim 12,
wherein the data content comprises an information describing a time at which the synchronization signal is transmitted or a time interval in which the synchronization signal is transmitted,
wherein the transceiver is configured to search for the synchronization signal at the time or within the time interval described by the information.

14. Transceiver as claimed in claim 1,
wherein the transceiver is configured to, in a background search mode or handover/cell reselection mode, to search for another presence indicator signal that is associated with another block of channels of the wireless communication system.

15. Transceiver as claimed in claim 14,
wherein the transceiver is configured to search, upon detecting the other presence indicator signal, to search for a synchronization signal in one or more channels of the other group of channels.

16. Transceiver as claimed in claim 1,
wherein the transceiver is configured to detect a primary synchronization signal that is repeated for a predefined number of symbols in a row as presence indicator signal.

17. Transceiver as claimed in claim 1,
wherein the transceiver is configured to detect a primary synchronization signal that is transmitted at a frequency position that does not coincide with a frequency position of a conventional synchronization signal as presence indicator signal,

18. Transceiver as claimed in claim 1,
wherein the transceiver is configured to detect a primary synchronization signal having another cell ID as presence indicator signal.

19. Transceiver as claimed in claim 1,
wherein the network search mode includes or is a cell search mode.

20. Transceiver as claimed in claim 1,
wherein the presence indicator signal comprises a synchronization signal block, SSB,
and/or wherein the synchronization signal comprises a synchronization signal block, SSB.

21. Transceiver as claimed in claim 1,
wherein the presence indicator signal comprises a synchronization signal block, SSB,
wherein the synchronization signal comprises a tracking reference signal.

22. Transceiver according to claim 1,
wherein the transceiver is configured to transmit a wake-up signal,
wherein the transceiver is configured to search for the presence indicator signal and/or the synchronization signal after transmitting the wake-up signal.

23. Transceiver according to claim 1,
wherein presence indicator signal is transmitted using a presence indicator signal beam,
wherein the presence indicator signal that is transmitted using said presence indicator signal beam is associated with one or more synchronization signal beams using which one or more synchronization signals are transmitted.

24. Transceiver according to claim 23,
wherein the transceiver is configured to receive the presence indicator signal that is transmitted using the presence indicator signal beam using a spatial filter,
wherein the transceiver is configured to receive the synchronization signal that is transmitted using a specific synchronization signal beam using the same spatial filter or a spatial filter derived therefrom.

25. Transceiver according to claim 1,
wherein the synchronization signal comprises a simplified synchronization signal block.

26. Transceiver according to claim 1,
wherein the presence indicator signal comprises a simplified synchronization signal block,
and/or wherein the transceiver is configured to receive the synchronization signal by searching for a physical broadcast channel.

27. Transceiver according to claim 26,
wherein the transceiver is configured to transmit a wake-up signal in response to a reception of the simplified synchronization signal block,
wherein the transceiver is configured to search for the physical broadcast channel in response to transmitting the wake-up signal.

28. Transceiver according to claim 27,
wherein the presence indicator signal or one or more resources using which the presence indicator signal is transmitted are associated with one or more resources in which a base station of the wireless communication network accepts the transmission of the wake-up signal.

29. Transceiver according to claim 25,
wherein the presence indicator signal comprises an information describing the one or more resources using which the synchronization signal is transmitted.

30. Transceiver according to claim 1,
wherein presence indicator signal comprises a discovery reference signal.
or wherein the synchronization signal comprises a discovery reference signal.

31. Transceiver according to claim 30,
wherein the transceiver is configured to transmit a wake-up signal in response to a reception of the discovery reference signal,
wherein the transceiver is configured to search for a synchronization signal block in response to transmitting the wake-up signal.

32. Transceiver according to claim 31,
wherein the presence indicator signal or one or more resources using which the presence indicator signal is transmitted are associated with one or more resources in which a base station of the wireless communication network accepts the transmission of the wake-up signal.

33. Transceiver according to claim 30,
wherein the presence indicator signal and/or the synchronization signal comprises an information describing the one or more resources using which the synchronization signal block is transmitted.

34. Transceiver according to claim 1,
wherein the transceiver is configured to receive the presence indicator signal from a secondary cell,
wherein the transceiver is configured to receive a synchronization signal block of a primary cell or anchor carrier as synchronization signal, or wherein the transceiver is configured to receive a tracking reference signal from a target cell.

35. Transceiver according to claim 34,
wherein the transceiver is configured to transmit a wake-up signal in response to a reception of the presence indicator signal,
wherein the transceiver is configured to receive the synchronization signal block or tracking reference signal in response to a reception of the wake-up signal.

36. Transceiver according to claim 35,
wherein the presence indicator signal or one or more resources using which the presence indicator signal is transmitted are associated with one or more resources in which a base station of the wireless communication network accepts the transmission of the wake-up signal.

37. Transceiver according to claim 34,
wherein the presence indicator signal and/or the synchronization signal comprises an information describing the one or more resources using which the synchronization signal block or tracking reference signal is transmitted.

38. Transceiver according to claim 1,
wherein the transceiver is configured to receive a system information block in response to a reception of a synchronization signal block as synchronization signal.

39. Transceiver according to claim 38,
wherein the transceiver is configured to receive the system information block from a primary cell or on an anchor carrier.

40. Transceiver according to claim 38,
wherein the transceiver is configured to transmit a wake-up signal and to receive the system information block in response to a reception of the wake-up signal.

41. Base station of a wireless communication network,
wherein the base station is configured to transmit a presence indicator signal, the presence indicator signal indicating a presence of
the wireless communication network, or
or a cell of the wireless communication network, or
or a beam of a cell of the wireless communication network,
wherein the presence indicator signal is associated in frequency with a group of frequencies used by the wireless communication network for transmitting one or more synchronization signals, the group of channels comprising at least two channels.

42. Base station as claimed in claim 41,
wherein the presence indicator signal is associated in time and frequency with a time-frequency area, the time-frequency area comprising in the frequency domain the group of channels and defining in the time domain a time interval.

43. Base station as claimed in claim 41,
wherein the group of channels is a group of synchronization frequency positions or a group of synchronization channels.

44. Base station as claimed in claim 41,
wherein the presence indicator signal comprises an information describing the group of channels.

45. Base station as claimed in claim 41,
wherein the presence indicator signal is transmitted on a frequency or channel having a predefined or pre-configured frequency relationship to the group of channels.

46. Base station as claimed in claim 41,
wherein the base station is configured to transmit the synchronization signal in the one or more channels of the group of channels,
or wherein the synchronization signal is transmitted by another base station in the one or more channels of the group of channels.

47. Base station as claimed in claim 41,
wherein the synchronization signal is transmitted in response to a wake-up signal.

48. Base station as claimed in claim 41,
wherein the base station is configured to transmit the presence indicator signal periodically.

49. Base station as claimed in claim 48,
wherein a periodicity of the transmission of the presence indicator signal is different than a periodicity of a transmission of a synchronization signal.

50. Base station as claimed in claim 49,
wherein a number of different channels of frequencies on which the presence indicator signal is transmitted is smaller than a number of channels on which the synchronization signal is transmitted.

51. Base station as claimed in claim 41,
wherein the base station is configured to transmit the presence indicator signal only in an energy saving mode.

52. Base station as claimed in claim 41,
wherein the base station is configured, in the energy saving mode, to not transmit synchronization signals,
or wherein the base station is configured, in the energy saving mode, to only transmit a synchronization signal on demand,
or wherein the base station is configured, in the energy saving mode, to transmit synchronization signals with a larger period when compared to a normal operation mode.

53. Base station as claimed in claim 41,
wherein the presence indicator signal comprises an information describing a current operation mode of the base station.

54. Base station as claimed in claim 41,
wherein the base station is configured to change a configuration of the transmission of the presence indicator signal in dependence on a condition of the cell or in response to a reception of wake-up signal.

55. Base station as claimed in claim 41,
wherein the presence indicator signal carries data content.

56. Base station as claimed in claim 55,
wherein the presence indicator signal carries the data content by means of one or more selected synchronization sequences included in the presence indicator signal, wherein the selected synchronization sequences are selected out of a plurality of different synchronization sequences in dependence on the data content to be transmitted, each of the different synchronization sequences being associated with different data content.

57. Base station as claimed in claim 55,
wherein the data content comprises an information describing a mode of operation of the base station.

58. Base station as claimed in claim 55,
wherein the data content comprises an information describing on which channel or channels of the block of channels a synchronization signal is transmitted.

59. Base station as claimed in claim 58,
wherein the data content comprises an information describing a time at which the synchronization signal is transmitted or a time interval in which the synchronization signal is transmitted.

60. Base station as claimed in claim 41,
wherein the base station is configured to transmit a coordination information to one or more other base stations of the wireless communication system for coordinating the transmission of presence indicator signals and/or synchronization signals.

61. Base station as claimed in claim 41,
wherein the base station is configured to receive, from another base station of the wireless communication system, a coordination information for coordinating the transmission of presence indicator signals and/or synchronization signals,
wherein the base station is configured to adjust a transmission of the presence indicator signal and/or a transmission of the synchronization signal based on the coordination information.

62. Base station as claimed in claim 60,
wherein the coordination information describes one or more out of
an operation mode,
transmission instances and/or a periodicity of a transmission of the presence indicator signal,
an absolute timing information for synchronizing transmission of presence indicator signals and/or synchronization signals,
transmission instances and/or a periodicity of a transmission of synchronization signals,
a request for transmitting the presence indicator signal,
a request for transmitting synchronization signals.

63. Base station as claimed in claim 41,
wherein the base station is configured to transmit the presence indicator signal using beam sweeping.

64. Base station as claimed in claim 41,
wherein the base station is configured to transmit the presence indicator signal using a number of beams that is smaller than a number of beams used for transmitting synchronization signals.

65. Base station as claimed in claim 41,
wherein the base station is configured to transmit the presence indicator signal using a power spectral density that is higher than a power spectral density used for transmitting synchronization signals.

66. Base station as claimed in claim 41,
wherein the base station is configured to use a coding scheme for transmitting the presence indicator signal.

67. Base station as claimed in claim 41,
wherein the base station is configured to use space-time-frequency block codes for transmitting the presence indicator signal.

68. Base station as claimed in claim 41,
wherein the base station is configured to transmit a primary synchronization signal that is repeated for a predefined number of symbols in a row as presence indicator signal.

69. Base station as claimed in claim 41,
wherein the base station is configured to transmit a primary synchronization signal at a frequency position that does not coincide with a frequency position of a conventional synchronization signal as presence indicator signal.

70. Base station as claimed in claim 41,
wherein the presence indicator signal comprises a synchronization signal block, SSB,
and/or wherein the synchronization signal comprises a synchronization signal block, SSB.

71. Base station as claimed in claim 41,
wherein the presence indicator signal comprises a synchronization signal block, SSB,
wherein the synchronization signal comprises a tracking reference signal.

72. Base station according to claim 41,
wherein the base station is configured to receive a wake-up signal,
wherein the base station is configured to transmit or to control another base station to transmit the presence indicator signal and/or the synchronization signal in response to receiving the wake-up signal.

73. Base station according to claim 41,
wherein the base station is configured to transmit the presence indicator signal using a presence indicator signal beam,
wherein the base station is configured to transmit one or more synchronization signals using one or more synchronization signal beams,
wherein the presence indicator signal beam is associated with one synchronization signal beam of the one or more synchronization signal beams.

74. Base station according to claim 41,
wherein the synchronization signal comprises a simplified synchronization signal block.

75. Base station according to claim 41,
wherein the presence indicator signal comprises a simplified synchronization signal block.

76. Base station according to claim 75,
wherein the base station is configured to receive a wake-up signal,
wherein the base station is configured to transmit a physical broadcast channel in response to the reception of the wake-up signal.

77. Base station according to claim 76,
wherein the presence indicator signal or one or more resources using which the presence indicator signal is transmitted are associated with one or more resources in which the base station accepts the transmission of the wake-up signal.

78. Base station according to claim 74,
wherein the presence indicator signal comprises an information describing the one or more resources using which the synchronization signal is transmitted.

79. Base station according to claim 41,
wherein presence indicator signal comprises a discovery reference signal.
or wherein the synchronization signal comprises a discovery reference signal.

80. Base station according to claim 79,
wherein the base station is configured to receive a wake-up signal,
wherein the base station is configured to transmit a synchronization signal block in response to the reception of the wake-up signal.

81. Base station according to claim 80,
wherein the presence indicator signal or one or more resources using which the presence indicator signal is transmitted are associated with one or more resources in which the base station accepts the transmission of the wake-up signal.

82. Base station according to claim 79,
wherein the presence indicator signal and/or the synchronization signal comprises an information describing the one or more resources using which the synchronization signal block is transmitted.

83. Base station according to claim 41,
wherein the base station is configured to transmit a synchronization signal block or tracking reference signal.

84. Base station according to claim 83,
wherein the base station is configured to receive a wake-up signal,
wherein the base station is configured to transmit the synchronization signal block or tracking reference signal in response to a reception of the wake-up signal.

85. Base station according to claim 84,
wherein the presence indicator signal or one or more resources using which the presence indicator signal is transmitted are associated with one or more resources in which the base station accepts the transmission of the wake-up signal.

86. Base station according to claim 83,
wherein the presence indicator signal and/or the synchronization signal comprises an information describing the one or more resources using which the synchronization signal block or tracking reference signal is transmitted.

87. Base station according to claim 41,
wherein the base station is configured to transmit or to control another base station to transmit a system information block in response to a reception of a wake-up signal.

88. Wireless communication network, comprising:
a transceiver as claimed in claim 1, and
a base station as claimed in claim 41.

89. Transceiver,
wherein the transceiver is configured, in a search mode, to search for a presence indicator signal, the presence indicator signal indicating a presence of a wireless communication network,
wherein the presence indicator signal is associated in frequency with a group of channels used by the wireless communication network, the group of channels comprising at least two channels,
wherein the transceiver is configured, upon detecting the presence indicator signal, to search for a broadcast signal in one or more channels of the group of channels.

90. Base station of a wireless communication network,
wherein the base station is configured to transmit a presence indicator signal, the presence indicator signal indicating a presence of the wireless communication network,
wherein the presence indicator signal is associated in frequency with a group of frequencies used by the wireless communication network for transmitting one or more synchronization signals, the group of channels comprising at least two channels.

91. Base station according to claim 90,
wherein the base station is configured to transmit a broadcast signal in one or more channels of the group of channels.

92. Transceiver,
wherein the transceiver is configured, in a search mode, to search for a presence indicator signal, the presence indicator signal indicating a presence of another transceiver,
wherein the presence indicator signal is associated in frequency with a group of channels used by the second transceiver, the group of channels comprising at least two channels,
wherein the first transceiver is configured, upon detecting the presence indicator signal associated in frequency with the group of channels used by the second transceiver, to search for a synchronization signal in one or more channels of the group of channels used by the other transceiver.

93. Transceiver according to claim 92,
wherein the transceiver and/or the other transceiver are configured to operate in a sidelink scenario.

94. Transceiver according to one of the claims 92,
wherein the synchronization signal is a sidelink synchronization signal block, SSB or a sidelink control information, SCI.

95. Other transceiver,
wherein the other transceiver is configured to transmit a presence indicator signal, the presence indicator signal indicating a presence of the other transceiver,
wherein the presence indicator signal is associated in frequency with a group of channels used by the second transceiver, the group of channels comprising at least two channels.

96. Other transceiver according to claim 95,
wherein the transceiver and/or the other transceiver are configured to operate in a sidelink scenario.

97. Other transceiver according to claim 95,
wherein the synchronization signal is a sidelink synchronization signal block, SSB or a sidelink control information, SCI.

98. Method for operating a transceiver, the method comprising:
searching, in a search mode, for a presence indicator signal, the presence indicator signal indicating a presence of
a wireless communication network, or
a cell of the wireless communication network, or
a beam of a cell of the wireless communication network,
wherein the presence indicator signal is associated in frequency with a group of channels used by the wireless communication network, the group of channels comprising at least two channels,
searching, upon detecting the presence indicator signal, for a synchronization signal in one or more channels of the group of channels.

99. Method for operating a base station of a wireless communication network, the method comprising:
transmitting a presence indicator signal, the presence indicator signal indicating a presence of
the wireless communication network, or
or a cell of the wireless communication network, or
or a beam of a cell of the wireless communication network,
wherein the presence indicator signal is associated in frequency with a group of channels used by the wireless communication network for transmitting one or more synchronization signals, the group of channels comprising at least two channels.

100. Method for operating a transceiver, the method comprising:
searching, in a search mode, for a presence indicator signal, the presence indicator signal indicating a presence of a wireless communication network,
wherein the presence indicator signal is associated in frequency with a group of channels used by the wireless communication network, the group of channels comprising at least two channels, searching, upon detecting the presence indicator signal, for a broadcast signal in one or more channels of the group of channels.

101. Method for operating a base station of a wireless communication network, the method comprising:
transmitting a presence indicator signal, the presence indicator signal indicating a presence of the wireless communication network,
wherein the presence indicator signal is associated in frequency with a group of channels used by the wireless communication network for transmitting one or more synchronization signals, the group of channels comprising at least two channels.

102. Method for operating a transceiver, the method comprising:
searching, in a search mode, for a presence indicator signal, the presence indicator signal indicating a presence of another transceiver,
wherein the presence indicator signal is associated in frequency with a group of channels used by the second transceiver, the group of channels comprising at least two channels,
searching, upon detecting the presence indicator signal associated in frequency with the group of channels used by the second transceiver, for a synchronization signal in one or more channels of the group of channels used by the other transceiver.

103. Method for operating another transceiver, the method comprising:
transmitting a presence indicator signal, the presence indicator signal indicating a presence of the other transceiver,
wherein the presence indicator signal is associated in frequency with a group of channels used by the second transceiver, the group of channels comprising at least two channels.

104. A non-transitory digital storage medium having a computer program stored thereon for performing a method as claimed in claim 98, when the computer program runs on a computer, microprocessor or software defined radio.
